(19) United States
(12) Patent Application Publication
(10) Pub. No.: US 2025/0042519 A1
(43) Pub. Date: Feb. 6, 2025

(54) ROLL STABILIZATION AND RELATED APPARATUSES

(71) Applicant: Dometic Marine Canada Inc., Richmond (CA)

(72) Inventors: Derry William LAPPIN, Vancouver (CA); Mark Isaac DYCK, Delta (CA); Trevor Daniel BOLEAC, Langley (CA); Noam Dean DAVIDSON, Vancouver (CA); Kevin Sean STOPP, Richmond (CA); Mackenzie Douglas HART, Vancouver (CA); Ray Tat Lung WONG, Richmond (CA)

(21) Appl. No.: 18/713,331

(22) PCT Filed: Nov. 23, 2022
(86) PCT No.: PCT/CA2022/051725

§ 371 Date: May 24, 2024

Related U.S. Application Data
(60) Provisional application No. 63/283,181, filed on Nov. 24, 2021.

(51) Int. Cl. B63B 39/04

(52) U.S. Cl. CPC B63B 39/04

(57) ABSTRACT

This disclosure relates generally to roll stabilization and related apparatuses.

### CROSS-REFERENCE TO RELATED APPLICATION

This application claims the benefit of, and priority to, U.S. provisional patent application No. 63/283,181 filed Nov. 24, 2021. The entire contents of U.S. provisional patent application No. 63/283,181 are incorporated by reference herein.

### FIELD

This disclosure relates generally to roll stabilization and related apparatuses.

### RELATED ART

A marine vessels may include a roll-stabilization apparatus. However, some known roll-stabilization apparatuses have some disadvantages.

### SUMMARY

According to at least one embodiment, a roll-stabilizer apparatus comprises: a flywheel-support body comprising a rotation-support body; a flywheel body surrounding at least a portion of the rotation-support body, wherein the rotation-support body supports the flywheel body for rotation relative to the flywheel-support body around at least one axis of rotation comprising a spin axis of rotation of the flywheel body and a central-rotation axis of the flywheel-support body; and a mounting body supporting the flywheel-support body and permitting rotation of the flywheel-support body relative to the mounting body around a precession axis non-parallel to the at least one axis of rotation.

According to at least one embodiment, a roll-stabilizer apparatus comprises: a flywheel body having a spin axis of rotation; a flywheel-support body having a central-rotation axis and comprising at least one magnetic bearing operable to support the flywheel body, the flywheel-support body permitting rotation of the flywheel body relative to the flywheel-support body around the spin axis of rotation at least when the spin axis of rotation is colinear with the central-rotation axis of the flywheel-support body; and a mounting body supporting the flywheel-support body and permitting rotation of the flywheel-support body relative to the mounting body around a precession axis non-parallel to the central-rotation axis of the flywheel-support body.

According to at least one embodiment, a roll-stabilizer apparatus comprises: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; and at least one precession-control device operable to control rotation of the flywheel-support body relative to the mounting body. The at least one precession-control device comprises: at least one actuator rotatably attached to the mounting body; and a first force-transfer body and a second force-transfer body, the first force-transfer body rotatably attached to each of the flywheel-support body, the at least one actuator, and the second force-transfer body, and the second force-transfer body further rotatably attached to the mounting body. The first force-transfer body is operable to transfer force at least between the at least one actuator and the flywheel-support body.

According to at least one embodiment, a roll-stabilizer apparatus comprises: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; and at least one precession-control device operable to control rotation of the flywheel-support body relative to the mounting body. The at least one precession-control device comprises: at least one actuator rotatably attached to the mounting body; and a first force-transfer body and a second force-transfer body, the first force-transfer body rotatably attached each of the mounting body, the at least one actuator, and the second force-transfer body, and the second force-transfer body further rotatably attached to the flywheel-support body. The first force-transfer body and the second force-transfer body are operable to transfer force at least between the at least one actuator and the flywheel-support body.

According to at least one embodiment, a roll-stabilizer apparatus comprises: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; at least one precession bearing operable to support the flywheel-support body for rotation relative to the mounting body around the precession axis; and at least one precession-control device operable to control rotation of the flywheel-support body relative to the mounting body and operable to apply a force at least partly overlapping a dimension of the at least one precession bearing along the precession axis.

According to at least one embodiment, a roll-stabilizer apparatus comprises: a flywheel body; a flywheel-support body supporting the flywheel body and permitting rotation of the flywheel body relative to the flywheel-support body around at least one axis of rotation comprising a spin axis of rotation of the flywheel body and a central-rotation axis of the flywheel-support body; a mounting body supporting the flywheel-support body and permitting rotation of the flywheel-support body relative to the mounting body around a precession axis non-parallel to the at least one axis of rotation; and at least one precession bearing operable to support the flywheel-support body for rotation relative to the mounting body around the precession axis, the at least one precession bearing comprising an outer precession body surrounding an inner precession body, the outer precession body rotatable relative to the inner precession body and relative to the mounting body.

According to at least one embodiment, a flywheel apparatus comprises a flywheel body rotatable around a spin axis of rotation and comprises a peripheral surface spaced apart from the spin axis of rotation, wherein the flywheel body defines a groove recessed in the peripheral surface.

According to at least one embodiment, an axial-magnetic-bearing apparatus comprises: an annular bearing body; and a plurality of electromagnets, each one of the plurality of electromagnets comprising a respective different electrical conductor, each one of the plurality of electromagnets positioned on the annular bearing body in a respective different annular sector of a plurality of annular sectors of the annular bearing body, the plurality of annular sectors surrounding a central-rotation axis of the annular bearing body. The electrical conductor of each one of the plurality of electromagnets extends transversely to the central-rotation axis of the annular bearing body such that each one of the plurality of electromagnets becomes magnetized in a direction along the central-rotation axis of the annular bearing body in response to, at least, an electrical current through the electrical conductor.

According to at least one embodiment, a marine vessel comprises: at least one hull; and the apparatus, wherein the mounting body is attached to the at least one hull.

Other aspects and features will become apparent to those ordinarily skilled in the art upon review of the following description of illustrative embodiments in conjunction with the accompanying figures.

### BRIEF DESCRIPTION OF THE DRAWINGS

FIG. 1 is a schematic illustration of a marine vessel according to one embodiment.

FIG. 2 is a perspective view of a roll-stabilizer apparatus of a roll-stabilizer assembly of the marine vessel of FIG. 1.

FIG. 3 is a cross-sectional view of the roll-stabilizer apparatus of FIG. 2, taken along the line labeled FIG. 3 in FIG. 2.

FIG. 4 is a perspective view of a mounting body of the roll-stabilizer apparatus of FIG. 2.

FIG. 5 is an exploded perspective view of a flywheel assembly of the roll-stabilizer apparatus of FIG. 2.

FIG. 6 is a cross-sectional view of a flywheel body of the flywheel assembly of FIG. 5.

FIG. 7 is an exploded perspective view of a flywheel-support body of the roll-stabilizer apparatus of FIG. 2.

FIG. 8 is an exploded perspective view of a radial active magnetic bearing including a rotor of the flywheel assembly of FIG. 5 and a stator of the flywheel-support body of FIG. 7.

FIG. 9 is a cross-sectional view of the radial active magnetic bearing of FIG. 8, taken along the line labeled FIG. 9 in FIG. 10 and in FIG. 11.

FIG. 10 is another cross-sectional view of the radial active magnetic bearing of FIG. 8, taken along the line labeled FIG. 10 in FIG. 9.

FIG. 11 is another cross-sectional view of the radial active magnetic bearing of FIG. 8, taken along the line labeled FIG. 11 in FIG. 9.

FIG. 12 is a perspective view of an electric coil of the radial active magnetic bearing of FIG. 8.

FIG. 13 is an exploded perspective view of a radial active magnetic bearing according to another embodiment.

FIG. 14 is a cross-sectional view of the radial active magnetic bearing of FIG. 13, taken along the line labeled FIG. 14 in FIG. 15.

FIG. 15 is another cross-sectional view of the radial active magnetic bearing of FIG. 13, taken along the line labeled FIG. 15 in FIG. 14.

FIG. 16 is a perspective view of an annular-sector stator body of the radial active magnetic bearing of FIG. 13.

FIG. 17 is an exploded perspective view of an axial active magnetic bearing of the flywheel-support body of FIG. 7.

FIG. 18 is a plan view of an assembled annular-sector body of the axial active magnetic bearing of FIG. 17, including the annular-sector body of FIG. 19.

FIG. 19 is a cross-sectional view of the axial active magnetic bearing of FIG. 17, taken along the line labeled FIG. 19 in FIG. 17.

FIG. 20 is a perspective view of an annular-sector body of the axial active magnetic bearing of FIG. 17.

FIG. 21 is an enlarged fragmentary view of FIG. 19.

FIG. 22 is the fragmentary view of FIG. 21, with the axial active magnetic bearing of FIG. 17 positioned in a groove of the flywheel body of FIG. 6.

FIG. 23 illustrates an example of changes over time in magnetic field experienced by a point on the flywheel body of FIG. 6.

FIG. 24 illustrates use of negative stiffness according to one embodiment.

FIG. 25 is a perspective view of a roll-stabilizer apparatus according to another embodiment.

FIG. 26 is an exploded perspective view of the roll-stabilizer apparatus of FIG. 25.

FIG. 27 is a cross-sectional view of a flywheel body and a flywheel-support body of the roll-stabilizer apparatus of FIG. 25, taken along the line labelled FIG. 27 in FIG. 25.

FIG. 28 is an enlarged fragmentary view of a bearing of the flywheel-support body of FIG. 27.

FIG. 29 is a fragmentary perspective view of a housing body of the flywheel-support body of FIG. 27 and a precession bearing of the roll-stabilizer apparatus of FIG. 25.

FIG. 30 is an enlarged fragmentary view of a portion of the flywheel-support body of FIG. 27 and another precession bearing of the roll-stabilizer apparatus of FIG. 25.

FIG. 31 is an exploded perspective view of a precession-control device of the roll-stabilizer apparatus of FIG. 25.

FIG. 32 is an exploded perspective view of another precession-control device of the roll-stabilizer apparatus of FIG. 25.

FIG. 33 is a side view of the roll-stabilizer apparatus of FIG. 25 with the precession-control device of FIG. 32 in an intermediate position.

FIG. 34 is a side view of the roll-stabilizer apparatus of FIG. 25 with the precession-control device of FIG. 32 in an extended position.

FIG. 35 is a side view of the roll-stabilizer apparatus of FIG. 25 with the precession-control device of FIG. 32 in a contracted position.

FIG. 36 is a circuit diagram of a braking circuit for an electric motor/generator of the roll-stabilizer apparatus of FIG. 25.

FIG. 37 is a circuit diagram of a damping circuit for an actuator motor of the roll-stabilizer apparatus of FIG. 25.

FIG. 38 is a perspective view of a roll-stabilizer apparatus according to another embodiment.

FIG. 39 is an exploded perspective view of a precession-control device of the roll-stabilizer apparatus of FIG. 38.

### DETAILED DESCRIPTION

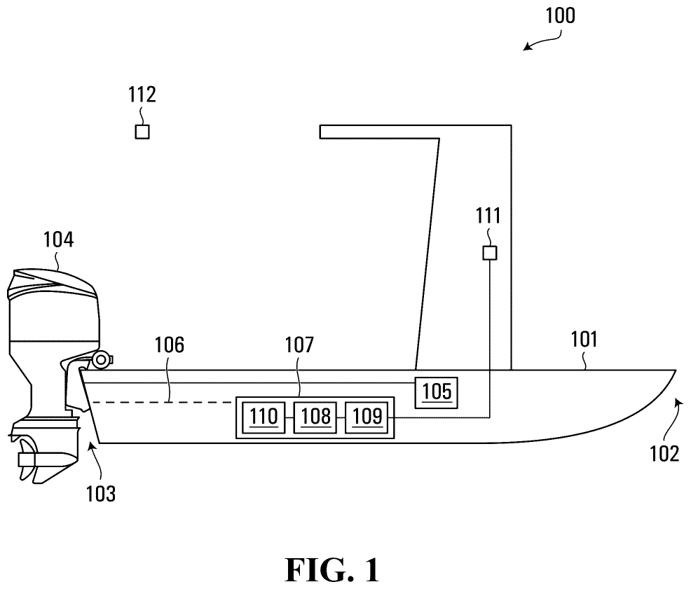

Referring to FIG. 1, a marine vessel according to one embodiment is shown generally at 100. The marine vessel 100 includes a hull 101 having a bow shown generally at 102. The hull 101 also has a stern shown generally at 103 and opposite the bow 102. At the stern 103, the marine vessel 100 includes a marine engine 104 operable to apply a thrust to the hull 101. The marine engine 104 in the embodiment shown is an outboard motor, but alternative embodiments may vary and may, for example, include one or more motors that may not necessarily be outboard motors. The marine vessel 100 also includes a main energy-storage device 105 that may be electrically connected to a starter motor of the marine engine 104 to power the starter motor, or that may be electrically connected to one or more other electrical devices of the marine vessel 100. The marine engine 104 may include an alternator to charge the main energy-storage device 105, or one or more other sources of electric current may charge the main energy-storage device 105. However, in alternative embodiments, the marine engine 104 may include an electric motor operable to apply a thrust to the hull 101, and the main energy-storage device 105 may be electrically connected to the electric motor to power the electric motor.

Herein, “electrically connected” may refer to any direct or indirect connection that permits a transfer of electrical energy, such as a direct electrical connection or an electrical connection involving inductive power transfer or other wired or wireless energy transfer, for example.

Also herein, “energy-storage device” may refer to one or more electrochemical cells, one or more batteries, one or more fuel cells, or one or more other devices operable to store electrical energy or other energy as described herein, or a combination of two or more thereof.

The marine vessel 100 has a longitudinal axis 106 extending between the bow 102 and the stern 103 of the hull 101. In general, “roll” herein may refer to movement that includes rotation of the hull 101 around the longitudinal axis 106.

The marine vessel 100 is an example only, and alternative embodiments may differ. For example, alternative embodiments are not limited to marine vessels and may not necessarily include marine vessels, and “roll” may refer to other types of movement of marine vessels or of other types of bodies. Some alternative embodiments may include more than one hull.

### Roll-Stabilizer Assembly

The marine vessel 100 also includes a roll-stabilizer assembly 107 including a roll-stabilizer apparatus 108, a roll-stabilizer controller 109, and a roll-stabilizer energy-storage device 110 distinct from the main energy-storage device 105. An alternator of the marine engine 104, one or more other sources of electric current, or both may charge the roll-stabilizer energy-storage device 110. The roll-stabilizer energy-storage device 110 may additionally or alternatively be charged as described below.

In some embodiments, some or all of the roll-stabilizer apparatus 108, the roll-stabilizer controller 109, and the roll-stabilizer energy-storage device 110 may be integrated into a single unit that may be attached directly or indirectly to the hull 101. Such an integrated unit may, in some embodiments, simplify installation, for example because such an integrated unit may require fewer electrical connections with other components of the marine vessel 100, or such an integrated unit may require less assembly. Further, such an integrated unit may, in some embodiments, allow transmission of electrical energy between the roll-stabilizer apparatus 108 and the roll-stabilizer energy-storage device 110 with shorter electrical conductors, and thus less wasted energy, when compared to other roll-stabilizer assemblies that involve external sources of electrical energy for a roll-stabilizer apparatus and longer electrical conductors. Further, such an integrated unit including the roll-stabilizer apparatus 108 and the roll-stabilizer energy-storage device 110 may, in some embodiments, reduce or avoid electrical energy required from external sources of electrical energy, and may continue to function despite a failure of an external source of electrical energy.

The marine vessel 100 also includes an inertial measurement unit 111 in communication with the roll-stabilizer controller 109 and operable to provide, to the roll-stabilizer controller 109, one or more signals indicating measurements, relative to an inertial frame of reference or another frame of reference, of linear acceleration, of rotational acceleration, of orientation, or a combination of two or more thereof of the hull 101 or of one or more other locations on the marine vessel 100 that may move with the hull 101. For example, the inertial measurement unit 111 may include one or more gyroscopes, one or more accelerometers, one or more other devices operable to measure linear acceleration, rotational acceleration, orientation, or a combination of two or more thereof of the hull 101 relative to an inertial frame of reference or another frame of reference. The inertial measurement unit 111 may be positioned at any location on the marine vessel 100. For example, in some embodiments, the inertial measurement unit 111 may be positioned on one or both of housing bodies 136 and 137 described below, or on one or both of housing bodies 244 and 245 described below. Further, in some embodiments, the inertial measurement unit 111 may include more than one device at one or more locations. However, alternative embodiments may omit the inertial measurement unit 111 or include one or more alternatives to the inertial measurement unit 111.

The roll-stabilizer controller 109 may include one or more processor circuits that may include one or more central processing unit (CPUs) or microprocessors, one or more machine learning chips, discrete logic circuits, or one or more application-specific integrated circuit (ASICs), or combinations of two or more thereof, for example, and that may include one or more of the same or different computer-readable storage media, which in various embodiments may include one or more of a read-only memory (ROM), a random access memory (RAM), a hard disc drive (HDD), a solid-state drive (SSD), and other computer-readable and/or computer-writable storage media. For example, one or more such computer-readable storage media may store program codes that, when executed, cause one or more processor circuits of the roll-stabilizer controller 109 to implement functions as described herein, for example, in which case the roll-stabilizer controller 109 may be programmed, configured, or operable to implement such functions. Of course the roll-stabilizer controller 109 may be configured or otherwise operable to implement other functions and to implement functions in other ways. For example, the roll-stabilizer controller 109 may be a single device or may include more than one device.

The roll-stabilizer controller 109 may include a wireless transmitter, a wireless receiver, a wireless transceiver, or two or more thereof to allow the roll-stabilizer controller 109 to receive one or more wireless signals directly or indirectly from, or transmit one or more wireless signals directly or indirectly to, a remote device 112. The remote device 112 may be a smartphone, a tablet computer, a smart watch, or smart glasses, for example. In the embodiment shown, the remote device 112 is detached from the marine vessel 100 and usable from outside of the marine vessel 100 and is therefore remote from the marine vessel 100. However, alternative embodiments may differ. For example, alternative embodiments may include one or more wired or other connections between the remote device 112 and the roll-stabilizer controller 109, and alternative embodiments may include devices on or integrated into the marine vessel 100 instead of the remote device 112.

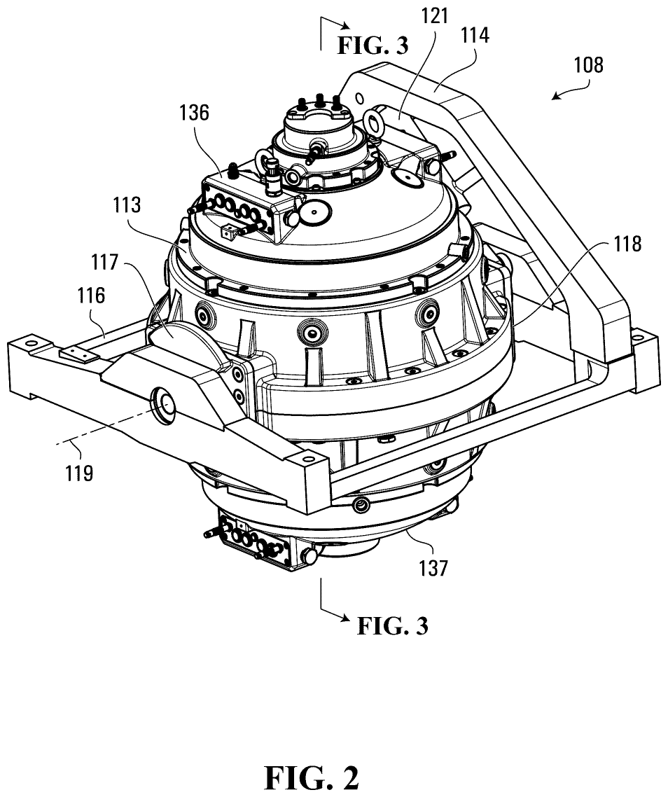

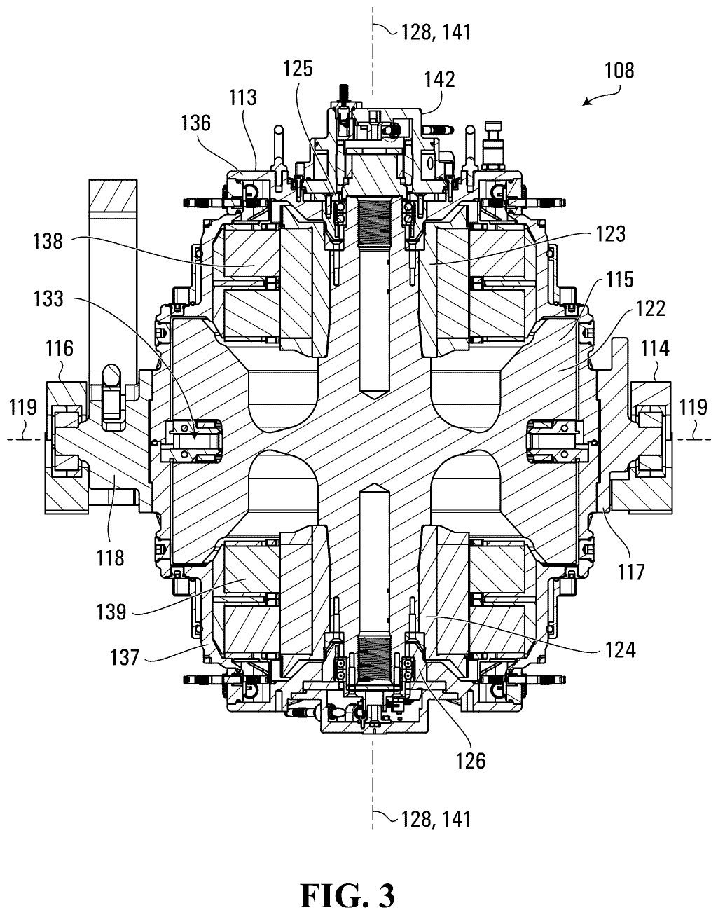

Referring to FIG. 2 and to FIG. 3, the roll-stabilizer apparatus 108 includes a flywheel-support body 113, a mounting body 114, and a flywheel assembly 115 in the flywheel-support body 113.

### Mounting Body

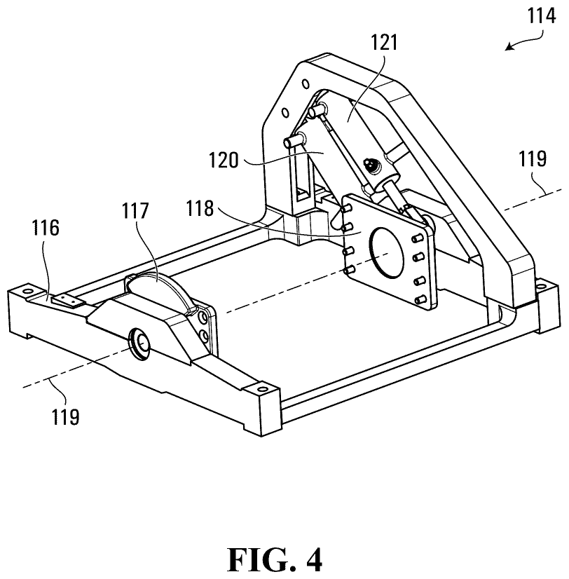

Referring to FIG. 4, the mounting body 114 includes a base 116 attachable to one or more other structures in the roll-stabilizer assembly 107, which may be attached to the hull 101 directly or indirectly to attach the mounting body 114, and thus the roll-stabilizer apparatus 108, to the hull 101. However, in alternative embodiments, the roll-stabilizer apparatus 108 may be attached directly or indirectly to the hull 101 in other ways, or the roll-stabilizer apparatus 108 may not be attached to any hull or to any marine vessel. Therefore, in some embodiments, measurements of linear acceleration, of rotational acceleration, of orientation, or a combination of two or more thereof of the hull 101, relative to an inertial frame of reference or another frame of reference, by the inertial measurement unit 111 may indicate such acceleration, orientation, or both of the mounting body 114 relative to such a frame of reference. Therefore, references herein to movement, acceleration, or orientation of the mounting body 114, relative to an inertial frame of reference or another frame of reference, may refer to movement, acceleration, or orientation, relative to such a frame of reference, of the inertial measurement unit 111 or of any other location that may be attached directly or indirectly to the mounting body 114 or that may otherwise move with mounting body 114.

The mounting body 114 also includes mounting brackets 117 and 118, each supported by a respective precession bearing and rotatable relative to the base 116 around a precession axis of rotation (or simply a precession axis) 119. The mounting brackets 117 and 118 are spaced apart from each other to define a space between the mounting brackets 117 and 118 to receive the flywheel-support body 113, and the mounting brackets 117 and 118 are each attachable to the flywheel-support body 113 such that when the flywheel-support body 113 is attached to the mounting brackets 117 and 118, the flywheel-support body 113 is attached to the mounting body 114 while the mounting body 114 permits the flywheel-support body 113 to rotate around the precession axis of rotation 119 relative to the base 116.

In some embodiments, movement of the flywheel-support body 113 relative to the mounting body 114 may be constrained to rotation of the flywheel-support body 113 relative to the mounting body 114 around the precession axis of rotation 119. However, alternative embodiments may differ. For example, in alternative embodiments, the flywheel-support body 113 may be mounted for both translation and rotation relative to the mounting body 114, for example using a linkage such as a four-bar linkage.

The mounting body 114 also includes precession-control devices 120 and 121. In general, a precession-control device may include an actuator, which may be a linear actuator or a torsional actuator, and which may be an electromechanical actuator, a hydraulic actuator, or a pneumatic actuator. Further, a precession-control device may include a shock absorber, a damper, an electric generator, or another device that can apply a resistive torque to the flywheel-support body 113 relative to the mounting body 114 to dampen the rotation of the flywheel-support body 113 relative to the mounting body 114.

The precession-control device 120 is a linear actuator rotatably attached to the base 116 and rotatably attached to the mounting bracket 118 at a distance away from the precession axis of rotation 119 such that linear extension or contraction of the precession-control device 120 may cause rotation of the mounting bracket 118 (and thus of the flywheel-support body 113) around the precession axis of rotation 119 relative to the base 116, and such that rotation of the flywheel-support body 113 (and thus of the mounting bracket 118) around the precession axis of rotation 119 relative to the base 116 may cause linear extension or contraction of the precession-control device 120.

Also, the precession-control device 121 is a linear actuator rotatably attached to the base 116 and rotatably attached to the mounting bracket 118 at a distance away from the precession axis of rotation 119 such that linear extension or contraction of the precession-control device 121 may cause rotation of the mounting bracket 118 (and thus of the flywheel-support body 113) around the precession axis of rotation 119 relative to the base 116, and such that rotation of the flywheel-support body 113 (and thus of the mounting bracket 118) around the precession axis of rotation 119 relative to the base 116 may cause linear extension or contraction of the precession-control device 121.

In some embodiments, each of the precession-control devices 120 and 121 may be a roller-screw actuator as described in United States patent application publication no. US 2020/0102053 A1, for example, and may be self-locking. For example, the actuators may be backdrivable and may include brakes to resist or prevent rotation of the flywheel-support body 113 relative to the mounting body 114. Such actuators may be simpler than other actuators, such as hydraulic actuators that may require handling hydraulic fluid and producing pressurized hydraulic fluid.

Each of the precession-control devices 120 and 121 is in communication with the roll-stabilizer controller 109 (shown in FIG. 1) to receive one or more control signals from the roll-stabilizer controller 109. Further, each of the precession-control devices 120 and 121 is an electromechanical actuator operable to extend and contract to apply a torque to, and to rotate, the mounting bracket 118 (and thus the flywheel-support body 113) around the precession axis of rotation 119 relative to the base 116 in response to, at least, one or more control signals from the roll-stabilizer controller 109. Such a torque applied by the precession-control devices 120 and 121 may differ from a resistive torque because, for example, a torque applied by the precession-control devices 120 and 121 may cause rotation of the mounting bracket 118 around the precession axis of rotation 119 relative to the base 116 in a same direction as the applied torque, and the applied torque may be independent of rotation of the mounting bracket 118 around the precession axis of rotation 119 relative to the base 116.

Further, each of the precession-control devices 120 and 121 is operable to generate electrical energy from rotation of the flywheel-support body 113 (and thus of the mounting bracket 118) around the precession axis of rotation 119 relative to the base 116 and thereby dampen precession of the flywheel-support body 113 around the precession axis of rotation 119 relative to the base 116. The precession-control devices 120 and 121 are electrically connected to the roll-stabilizer energy-storage device 110 such that electrical energy generated by the precession-control devices 120 and 121 may be stored by the roll-stabilizer energy-storage device 110.

In some embodiments, minimizing backlash or lost motion between the flywheel-support body 113 and the precession-control devices 120 and 121, or between the mounting body 114 and the precession-control devices 120 and 121, may be important for control stability.

However, alternative embodiments may differ. For example, alternative embodiments may include more or fewer precession-control devices that may differ from the precession-control devices 120 and 121. For example, a precession-control device according to an alternative embodiment may include a different electromechanical actuator, a different electric generator, or both, and some embodiments may omit such precession-control devices. Further, alternative embodiments may differ and may include hydraulic actuators, torsional actuators, or both, for example. Also, precession-control devices of alternative embodiments need not be actuators, but could apply only resistive forces or torques that simply resist or dampen movement of the flywheel-support body 113 relative to the mounting body 114.

### Flywheel Assembly

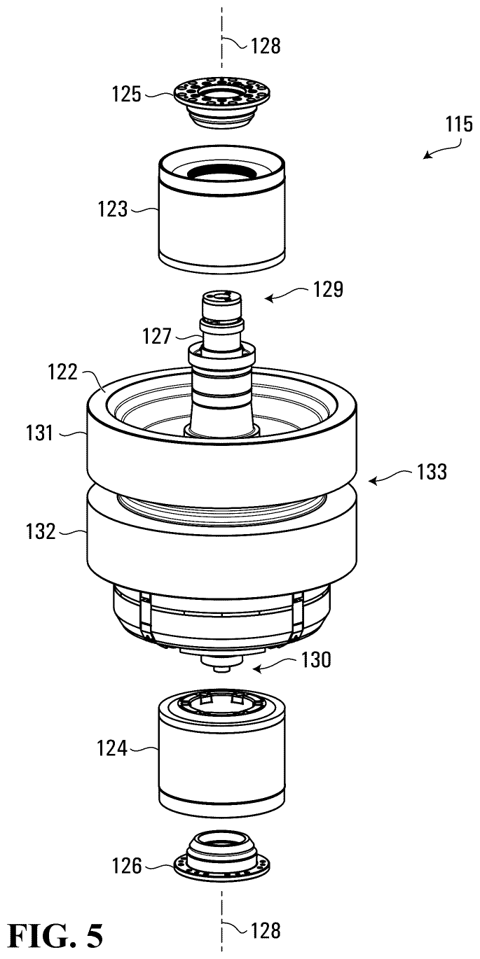

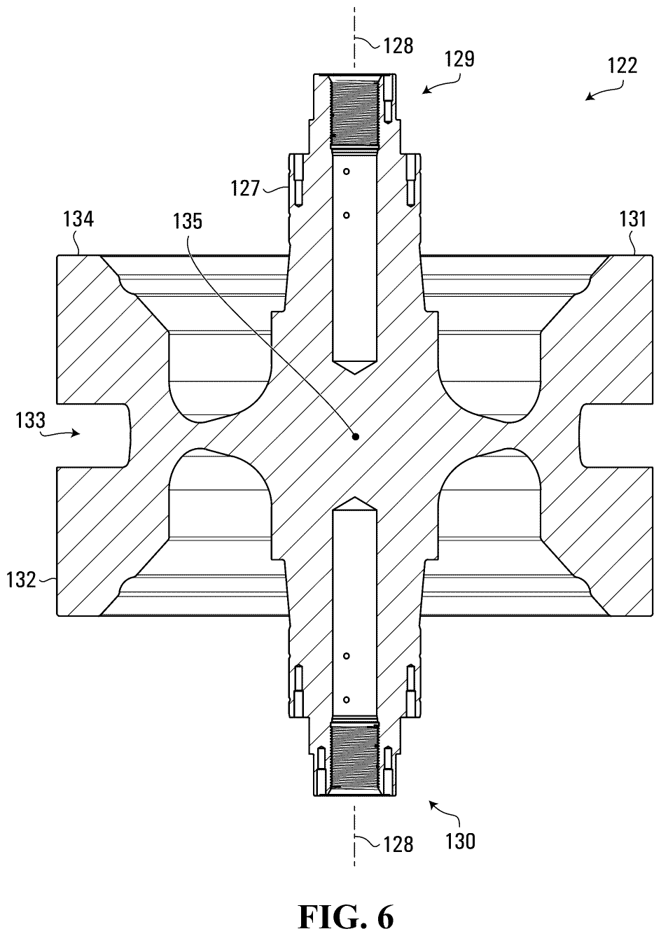

Referring to FIG. 5 and to FIG. 6, the flywheel assembly 115 includes a flywheel body 122, rotors 123 and 124, and touchdown bearings in touchdown-bearing assemblies 125 and 126. The flywheel body 122 has a shaft 127 extending along a spin axis of rotation 128 between opposite ends shown generally at 129 and 130 of the shaft 127. The rotor 123 may be attached to the shaft 127 at the end 129, and the rotor 124 attached to the shaft 127 at the end 130. The spin axis of rotation 128 may be through a center of mass of the flywheel assembly 115 and through centers of the opposite ends 129 and 130, although the flywheel assembly 115 does not necessarily have to spin around spin axis of rotation 128. In some embodiments, the flywheel assembly 115 may spin in other ways.

A wheel portion 131 surrounds the shaft 127 and the spin axis of rotation 128, and much of the wheel portion 131 is spaced apart from the spin axis of rotation 128 to increase a moment of inertia of the flywheel body 122. An outer (or outermost) peripheral surface 132 of the wheel portion 131 also surrounds the shaft 127 and the spin axis of rotation 128, and is generally cylindrical around the spin axis of rotation 128. However, the wheel portion 131 of the flywheel body 122 defines a groove (or taper cut) shown generally at 133 and recessed in the outer peripheral surface 132. Alternative embodiments may differ. For example, a wheel portion of an alternative embodiment may include a groove in a peripheral surface that is not necessarily an outer or outermost peripheral surface of the wheel portion, and that may be an inner surface of a flywheel body, for example. Such a surface may be cylindrical, or may be generally cylindrical (for example, not exactly cylindrical but similar to cylindrical).

Because the wheel portion 131 of the flywheel body 122 defines the groove 133, a point of peak stress of the flywheel body 122 during rotation of flywheel body 122 around the spin axis of rotation 128 may be at a location 134, as opposed to a location 135 that may be a point of peak stress of the flywheel body 122 if the flywheel body 122 omitted the groove 133. The location 134 is closer to a surface of the wheel portion 131 than the location 135, so the point of peak stress at the location 134 may be preferable to the point of peak stress at the location 135, for example because the location 134 is closer to a surface of the wheel portion 131 that may be heat-treated.

The flywheel assembly 115 is an example only, and alternative embodiments may differ.

### Flywheel-Support Body

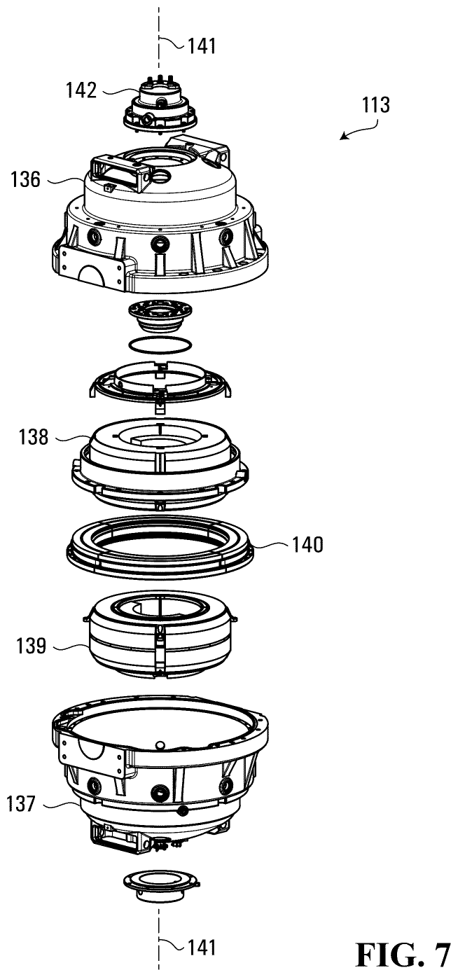

Referring to FIG. 7, the flywheel-support body 113 includes housing bodies 136 and 137 that, when assembled as shown in FIG. 2 and in FIG. 3, form a housing that houses the flywheel assembly 115. The housing bodies 136 and 137 may be hemispheric bodies in some embodiments, and the housing formed by the housing bodies 136 and 137 may include very low air pressure, a slippery gas, helium, some other gas or mixture of gases, or a vacuum in some embodiments. More specifically, the housing formed by the housing bodies 136 and 137 may form a seal to contain an internal environment different than an ambient external environment. For example, the seal may be an air-tight seal, and the internal environment may have a different pressure than ambient pressure, or may contain gases or mixtures of gases different than ambient air. Thus, for example, in some embodiments the housing formed by the housing bodies 136 and 137 may enclose the flywheel assembly 115 in an environment that has a pressure lower than ambient pressure, such as a vacuum, or that includes a slippery gas, helium, or some other gas or mixture of gases. The flywheel-support body 113 also includes, within the housing formed by the housing bodies 136 and 137, stators 138 and 139 and an axial active magnetic bearing 140. In general, the flywheel-support body 113 has a central-rotation axis 141. The central-rotation axis 141 is perpendicular to the precession axis of rotation 119. In alternative embodiments, the central-rotation axis 141 may be non-parallel to, and not necessarily perpendicular to, the precession axis of rotation 119. The central-rotation axis 141 is not necessarily at an exact center of the flywheel-support body 113 or of any other structure.

The flywheel-support body 113 is operable to support the flywheel assembly 115 such that the flywheel assembly 115 is rotatable within the flywheel-support body 113 at least when the spin axis of rotation 128 is colinear with the central-rotation axis 141. However, the spin axis of rotation 128 does not necessarily have to be colinear with the central-rotation axis 141, and a target axis for the spin axis of rotation 128 may be colinear with the central-rotation axis 141, or close to but not necessarily colinear with the central-rotation axis 141.

The flywheel-support body 113 also includes an electric motor/generator 142 electrically connected (either directly or indirectly, such as indirectly through the roll-stabilizer controller 109) to the roll-stabilizer energy-storage device 110 (shown in FIG. 1) such that the electric motor/generator 142 may use electric energy stored by the roll-stabilizer energy-storage device 110 to apply a torque to the flywheel assembly 115 (and thus to the flywheel body 122) around the spin axis of rotation 128 relative to the flywheel-support body 113. In some embodiments, the electric motor/generator 142 may have multiple different windings to facilitate generating different torque profiles, which may provide higher rates of acceleration or deceleration. As used herein, the term “electric motor/generator” excludes any electrical or other connections, such as wires, studs, or plugs.

Further, the electric motor/generator 142 may convert rotational kinetic energy, from rotation of the flywheel assembly 115 (and thus from the flywheel body 122) around the spin axis of rotation 128 relative to the flywheel-support body 113, to electrical energy, and the electric motor/generator 142 is electrically connected to the roll-stabilizer energy-storage device 110 such that the roll-stabilizer energy-storage device 110 may receive and store such electrical energy converted from such rotational kinetic energy.

In some embodiments, the electric motor/generator 142 may be located entirely within the housing formed by the housing bodies 136 and 137. As such, when the housing formed by the housing bodies 136 and 137 encloses the flywheel assembly 115 in an internal environment different than an ambient external environment, the electric motor/generator 142 may also be contained in this internal environment. In such embodiments, electrical connections (not shown) to the electric motor/generator 142 could pass through one or both of the housing bodies 136 and 137.

The electric motor/generator 142 is an example only, and alternative embodiments may differ. For example, an alternative embodiment may include only an electric motor, or may include an electric motor and an electric generator separate from the electric motor. Further, an alternative embodiment may include more than one electric motor, more than one electric generator, or more than one electric motor/generator that may differ from the electric motor/generator 142. Also, alternative embodiments could generate torque in other ways. For example, alternative embodiments may include a hydraulic pump and motor, or could use air power. Further, as described below for example, one or more magnetic bearings may apply a torque to the flywheel assembly 115. Also, in some embodiments, a motor may have an output shaft that is spaced apart from the the central-rotation axis 141.

More generally, the flywheel-support body 113 is an example only, and alternative embodiments may differ.

The flywheel-support body 113 may also include one or more proximity sensors, one or more position sensors, or both that are operable to provide, to the roll-stabilizer controller 109 (shown in FIG. 1), one or more signals indicating measurements of proximity or position of the flywheel assembly 115 relative to the flywheel-support body 113. For example, such one or more sensors may include one or more optical sensors, one or more magnetic sensors (such as one or more eddy-current sensors, for example), one or more capacitive sensors, one or more inductive sensors (for example, one or more sensors of inductance of one or more magnetic bearings as described herein), one or more other proximity sensors, one or more other position sensors, or a combination of two or more thereof.

### Homopolar Radial Magnetic Bearing

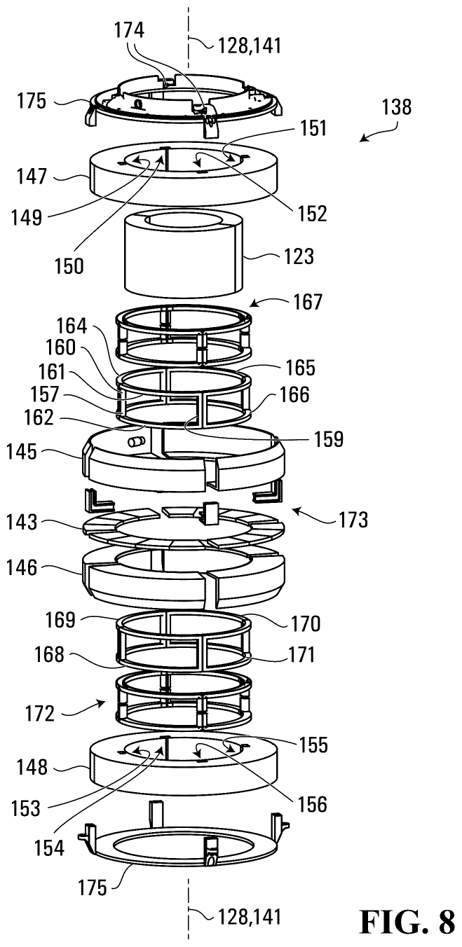

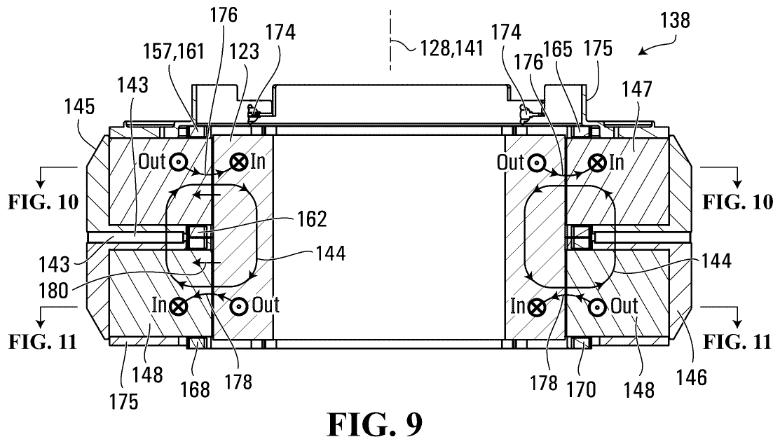

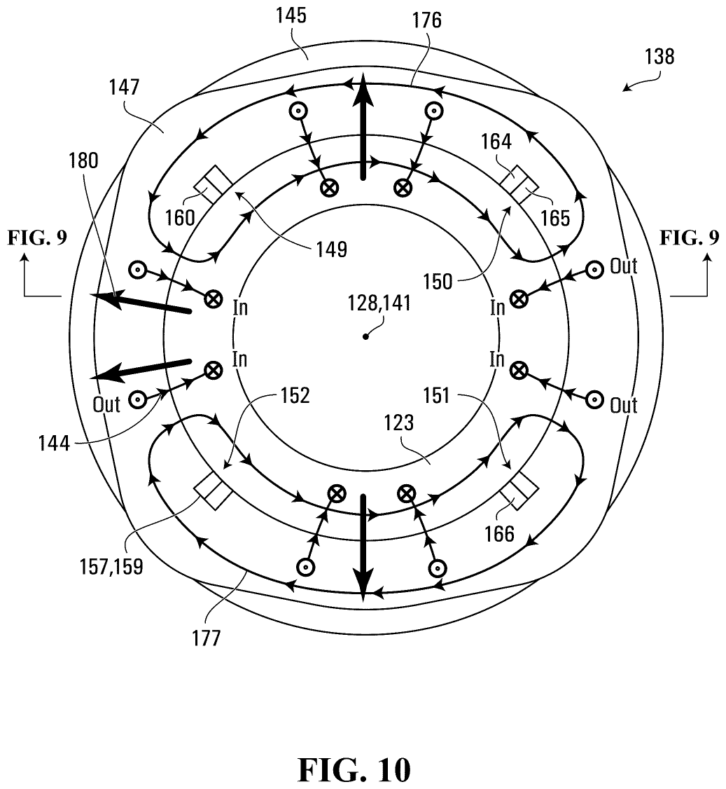

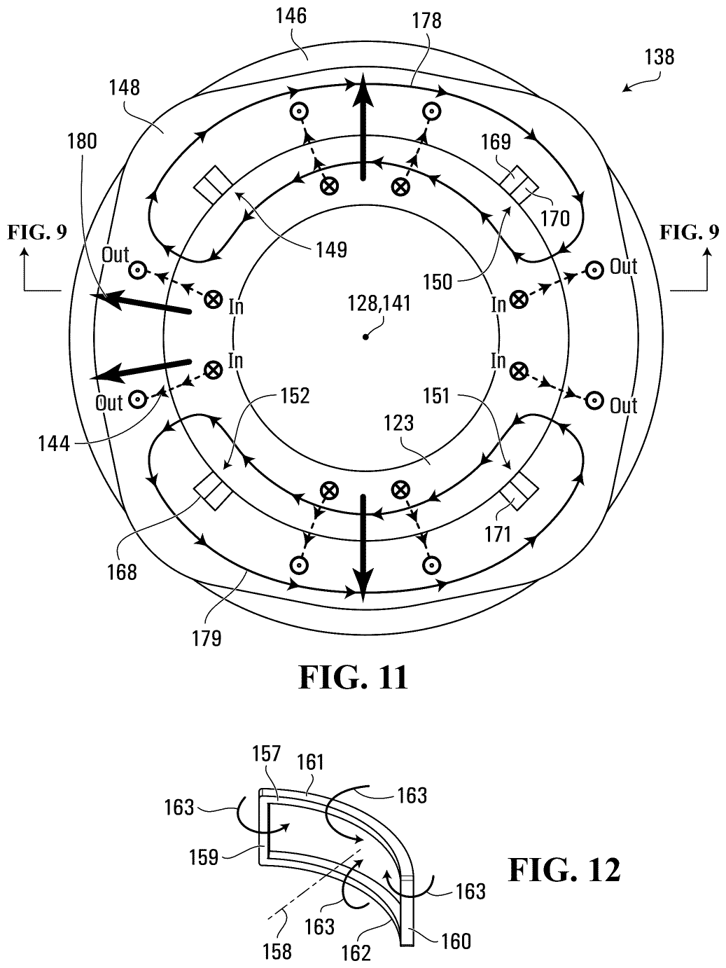

Referring to FIG. 8, to FIG. 9, to FIG. 10, and to FIG. 11, the rotor 123 (also shown in FIG. 5) is a cylindrically shaped assembly of steel laminations stacked in a direction along the central-rotation axis 141. The rotor 124 (also shown in FIG. 5) may be similar to the rotor 123. However, the rotor 123 is an example only, and alternative embodiments may differ. For example, alternative embodiments may include more or fewer components, or one or more alternatives to the components described above. For example, an alternative embodiment may include materials that differ from the materials described above.

The stator 138 (also shown in FIG. 7) includes a row of permanent magnets 143 in a generally annular shape around the central-rotation axis 141. However, alternative embodiments may include one or more electromagnets or other magnets additionally or alternatively to the permanent magnets 143. The permanent magnets 143 are magnetized in a direction along the central-rotation axis 141 and create a bias magnetic field as shown by magnetic-field arrows 144. The magnetization direction of the permanent magnets 143 as shown in FIG. 9, in FIG. 10, and in FIG. 11 is an example only, and the magnetization direction may be opposite or otherwise different in other embodiments.

Steel pieces 145 and 146 are on opposite sides, along the central-rotation axis 141, of the permanent magnets 143. The steel pieces 145 and 146 may function as back-iron flux distributors.

Also on opposite sides, along the central-rotation axis 141, of the permanent magnets 143 are cylindrically shaped axially stacked lamination-steel bodies 147 and 148. The lamination-steel bodies 147 and 148 could additionally or alternatively be made of soft-magnetic-composite (SMC), similar low-loss magnetic steels, sintered magnetic materials, laminations, or other materials, and alternative embodiments may have topologies that differ from the topology shown. The lamination-steel body 147 is between the steel piece 145 and the rotor 123, and the lamination-steel body 148 is between the steel piece 146 and the rotor 123. The lamination-steel body 147 is generally annular, and an inner surface of the lamination-steel body 147 defines axially extending grooves shown generally at 149, 150, 151, and 152. The lamination-steel body 148 is also generally annular, and an inner surface of the lamination-steel body 148 defines axially extending grooves shown generally at 153, 154, 155, and 156.

The rotor 123 and the lamination-steel bodies 147 and 148 may be sized and positioned such that a gap (which may be an air gap in some embodiments) is between the rotor 123 and the lamination-steel bodies 147 and 148. Such a gap may facilitate generation of magnetic forces as described herein, for example.

Referring to FIG. 8, to FIG. 10, to FIG. 11, and to FIG. 12, the stator 138 also includes an electric coil 157 including an electric conductor (such as copper) coiled around an axis 158 extending through and across the electric coil 157. The coil has axial portions 159 and 160 and peripheral portions 161 and 162 between the axial portions 159 and 160. When an electric current passes through the electric coil 157 in a clockwise direction from the perspective of the central-rotation axis 141 (or clockwise in the orientation of FIG. 12), the electric coil 157 produces a magnetic field as shown by magnetic-field arrows 163, and when an electric current passes through the electric coil 157 in a counter-clockwise direction from the perspective of the central-rotation axis 141 (or counter-clockwise in the orientation of FIG. 12), the electric coil 157 produces a magnetic field opposite the magnetic-field arrows 163 in FIG. 12. The axial portion 159 is received in the groove 152, and the axial portion 160 is received in the groove 149. The peripheral portions 161 and 162 are therefore on opposite sides, along the central-rotation axis 141, of the lamination-steel body 147.

The stator 138 also includes an electric coil 164 that may be similar to the electric coil 157, although axial portions of the electric coil 164 are received in the grooves 149 and 150.

The stator 138 also includes an electric coil 165 that may be similar to the electric coil 157, although axial portions of the electric coil 165 are received in the grooves 150 and 151.

The stator 138 also includes an electric coil 166 that may be similar to the electric coil 157, although axial portions of the electric coil 166 are received in the grooves 151 and 152.

The stator 138 also includes electric insulators shown generally at 167, each for surrounding and electrically insulating a respective one of the electric coils 157, 164, 165, and 166.

The stator 138 also includes an electric coil 168 that may be similar to the electric coil 157, although axial portions of the electric coil 168 are received in the grooves 153 and 156, and peripheral portions of the electric coil 168 are on opposite sides, along the central-rotation axis 141, of the lamination-steel body 148.

The stator 138 also includes an electric coil 169 that may be similar to the electric coil 168, although axial portions of the electric coil 169 are received in the grooves 153 and 154.

The stator 138 also includes an electric coil 170 that may be similar to the electric coil 168, although axial portions of the electric coil 170 are received in the grooves 154 and 155.

The stator 138 also includes an electric coil 171 that may be similar to the electric coil 168, although axial portions of the electric coil 171 are received in the grooves 155 and 156.

The stator 138 also includes electric insulators shown generally at 172, each for surrounding and electrically insulating a respective one of the electric coils 168, 169, 170, and 171.

The stator 138 also includes wire guides shown generally at 173 for guiding wires or other electric conductors electrically connected to one, more than one, or all of the electric coils 157, 164, 165, 166, 168, 169, 170, and 171. The electric coils 157, 164, 165, 166, 168, 169, 170, and 171 are electrically connected to the roll-stabilizer energy-storage device 110 (either directly or indirectly, such as indirectly through the roll-stabilizer controller 109) and may receive electric current from the roll-stabilizer energy-storage device 110 (shown in FIG. 1), and the roll-stabilizer controller 109 (also shown in FIG. 1) may control electric current through each of the electric coils 157, 164, 165, 166, 168, 169, 170, and 171 independently such that electric current through one of the electric coils 157, 164, 165, 166, 168, 169, 170, and 171 may be independent from electric current through one, more than one, or all of the others of the electric coils 157, 164, 165, 166, 168, 169, 170, and 171.

When the stator 138 is assembled as shown in FIG. 9, in FIG. 10, and in FIG. 11, peripheral portions of the electric coils 157, 164, 165, 166, 168, 169, 170, and 171 that are axially between the lamination-steel bodies 147 and 148 are also radially between the rotor 123 and the permanent magnets 143.

The stator 138 also includes a radial sensor mount 174 that may be used to mount one or more sensors, and a clamp 175 may be used for retention.

Referring to FIG. 9, to FIG. 10, and to FIG. 11, the bias magnetic field as shown by the magnetic-field arrows 144 is generally toroidal (or generally rectangular in a cross-section along the central-rotation axis 141) and passes through the permanent magnets 143, through the lamination-steel body 147, through the rotor 123 and around the peripheral portions of the electric coils 157, 164, 165, 166, 168, 169, 170, and 171 that are axially between the lamination-steel bodies 147 and 148, through the lamination-steel body 148, and back through the permanent magnets 143.

In general, the bias magnetic field as shown by the magnetic-field arrows 144 creates magnetic forces that are generally radial relative to the spin axis of rotation 128 and that attract the rotor 123 towards the stator 138 radially relative to the spin axis of rotation 128. Such attractive magnetic forces from the bias magnetic fields as shown by the magnetic-field arrows 144 may be uniform or similar around the spin axis of rotation 128, so the rotor 123 and the stator 138 therefore may function as a radial magnetic bearing (that may be known as a homopolar magnetic bearing) that may align the spin axis of rotation 128 to the central-rotation axis 141.

Referring to FIG. 9, to FIG. 10, and to FIG. 11, when an electric current passes through the electric coil 157 in a counter-clockwise direction from the perspective of the central-rotation axis 141 (or counter-clockwise in the orientation of FIG. 12), when an electric current passes through the electric coil 165 in a clockwise direction from the perspective of the central-rotation axis 141, when an electric current passes through the electric coil 168 in a clockwise direction from the perspective of the central-rotation axis 141, and when an electric current passes through the electric coil 170 in a counter-clockwise direction from the perspective of the central-rotation axis 141,
1. a control magnetic field as shown by magnetic-field arrows 176 passes around the axial portion 160 of the electric coil 157, through the rotor 123, around an axial portion of the electric coil 165, through the lamination-steel body 147, and back around the axial portion 160 of the electric coil 157,
2. a control magnetic field as shown by magnetic-field arrows 177 passes around the axial portion 159 of the electric coil 157, through the rotor 123, around an axial portion of the electric coil 165, through the lamination-steel body 147, and back around the axial portion 159 of the electric coil 157,
3. a control magnetic field as shown by magnetic-field arrows 178 passes around an axial portion of the electric coil 168, through the lamination-steel body 148, around an axial portion of the electric coil 170, through the rotor 123, and back around the axial portion of the electric coil 168, and
4. a control magnetic field as shown by magnetic-field arrows 179 passes around an axial portion of the electric coil 168, through the lamination-steel body 148, around an axial portion of the electric coil 170, through the rotor 123, and back around the axial portion of the electric coil 168.

As shown in FIG. 9, in FIG. 10, and in FIG. 11, on a side of the stator 138 having the electric coils 157 and 168, the control magnetic fields as shown by the magnetic-field arrows 176, 177, 178, and 179 are in the same direction as the bias magnetic fields as shown by the magnetic-field arrows 144, so the control magnetic fields as shown by the magnetic-field arrows 176, 177, 178, and 179 complement or enhance the bias magnetic fields as shown by the magnetic-field arrows 144 and strengthen the magnetic attraction of the rotor 123 towards the side of stator 138 having the electric coils 157 and 168.

As also shown in FIG. 9, in FIG. 10, and in FIG. 11, on a side of the stator 138 having the electric coils 165 and 170 (opposite the side of the stator 138 having the electric coils 157 and 168), the control magnetic fields as shown by the magnetic-field arrows 176, 177, 178, and 179 are in an opposite direction from the bias magnetic fields as shown by the magnetic-field arrows 144, so the control magnetic fields as shown by the magnetic-field arrows 176, 177, 178, and 179 counter or diminish the bias magnetic fields as shown by the magnetic-field arrows 144 and weaken the magnetic attraction of the rotor 123 towards the side of stator 138 having the electric coils 157 and 168.

As a result, when an electric current passes through the electric coil 157 in a counter-clockwise direction from the perspective of the central-rotation axis 141 (or counter-clockwise in the orientation of FIG. 12), when an electric current passes through the electric coil 165 in a clockwise direction from the perspective of the central-rotation axis 141, when an electric current passes through the electric coil 168 in a clockwise direction from the perspective of the central-rotation axis 141, and when an electric current passes through the electric coil 170 in a counter-clockwise direction from the perspective of the central-rotation axis 141, the electric coils 157, 165, 168, and 170 cause a net magnetic force 180 radially towards the side of the stator 138 having the electric coils 157 and 168, so the rotor 123 and the stator 138 therefore may function as an active radial magnetic bearing having radial forces controllable at least in part by controlling electric currents through the electric coils 157, 165, 168, and 170.

If directions of the electric currents through the electric coils 157, 165, 168, and 170 are reversed from the directions described in the example above, then the electric currents would cause a net magnetic force opposite the net magnetic force 180 and radially towards the side of the stator 138 having the electric coils 165 and 170. Further, the example described above involves electric currents through the electric coils 157, 165, 168, and 170, but similar radial forces towards or away from a side of the stator 138 having the electric coils 164 and 169 or a side of the stator 138 having the electric coils 166 and 171 may be controlled at least in part by controlling electric currents through the electric coils 164, 166, 169, and 171.

In general, diametrically opposed electric coils may cooperate to control radial magnetic forces. Therefore, in some embodiments, the electric coils 157, 165, 168, and 170 may be electrically connected to each other, the electric coils 164, 166, 169, and 171 may be electrically connected to each other, and the roll-stabilizer controller 109 (also shown in FIG. 1) may control electric current through the electric coils 157, 165, 168, and 170 independently from electric current through the electric coils 164, 166, 169, and 171.

The stator 139 (also shown in FIG. 7) may be similar to the stator 138. However, the stator 138 is an example only, and alternative embodiments may differ. For example, alternative embodiments may include more or fewer components, or one or more alternatives to the components described above. For example, an alternative embodiment may include materials that differ from the materials described above. Alternative embodiments may also include passive magnetic bearings in place of or in addition to the the rotor 123 and the stator 138.

### E-Core Radial Magnetic Bearing

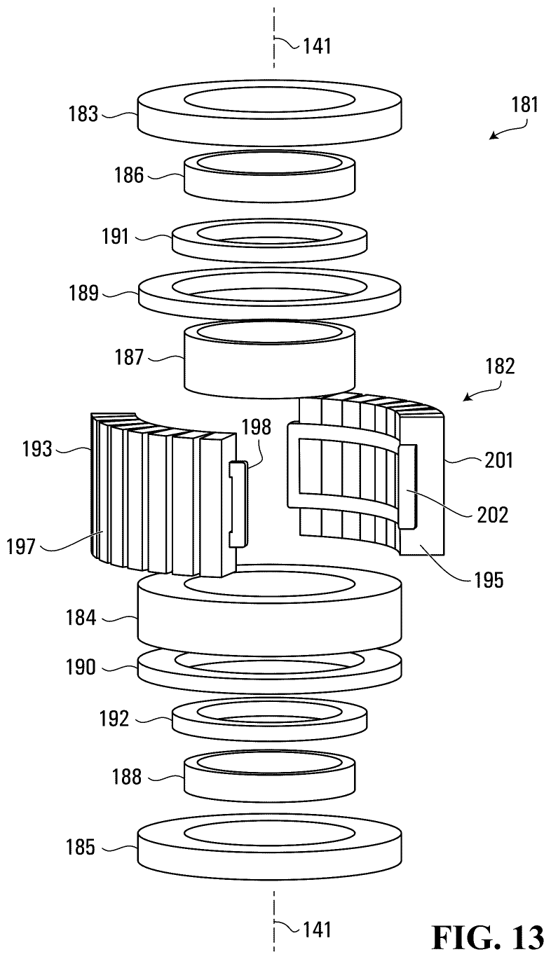

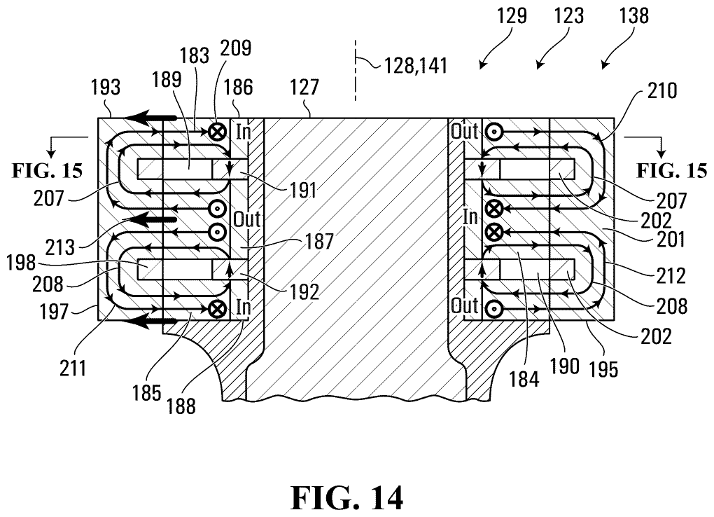

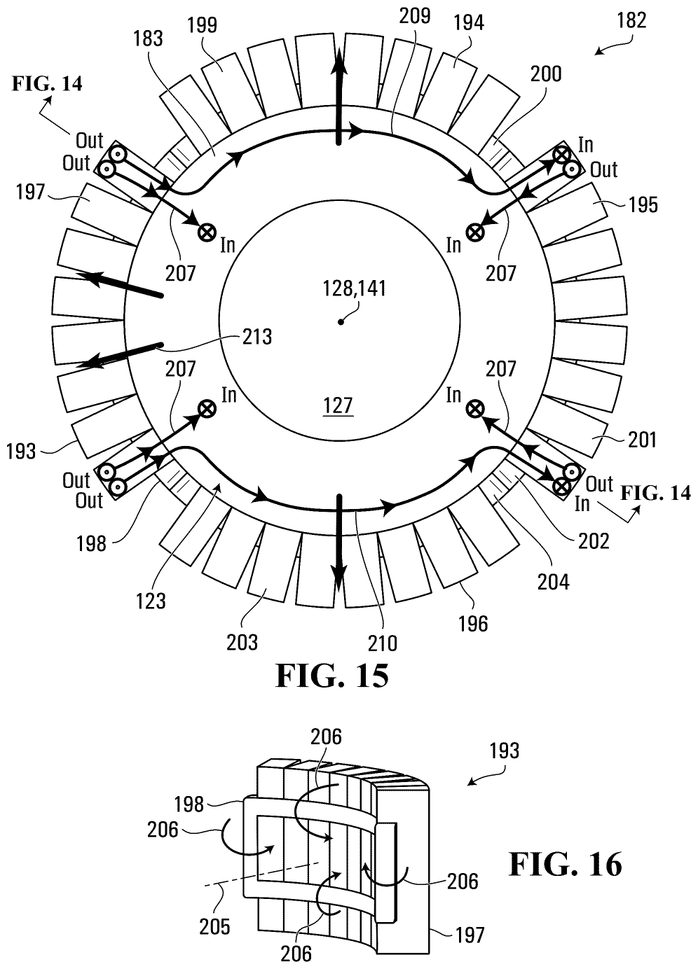

Referring to FIG. 13, to FIG. 14, and to FIG. 15, an alternative embodiment includes a rotor 181 and a stator 182. In the embodiment of FIG. 13, FIG. 14, and FIG. 15, the flywheel assembly 115 may include the rotor 181 as an alternative to the rotor 123, to the rotor 124, or to both, so FIG. 13, FIG. 14, and FIG. 15 illustrate the spin axis of rotation 128 as in the embodiment of FIG. 8, FIG. 9, FIG. 10, and FIG. 11. Likewise, in the embodiment of FIG. 13, FIG. 14, and FIG. 15, the flywheel-support body 113 may include the stator 182 as an alternative to the stator 138, to the stator 139, or to both, so FIG. 13, FIG. 14, and FIG. 15 illustrate the central-rotation axis 141 as in the embodiment of FIG. 8, FIG. 9, FIG. 10, and FIG. 11.

The rotor 181 includes lamination rings 183, 184, and 185. The rotor 181 also includes a solid-steel ring 186 inside the lamination ring 183, a solid-steel ring 187 inside the lamination ring 184, and a solid-steel ring 188 inside the lamination ring 185. The rotor 181 also includes a non-magnetic ring (such as a stainless-steel ring) 189 between the lamination rings 183 and 184, and a non-magnetic ring (such as a stainless-steel ring) 190 between the lamination rings 184 and 185. The rotor 181 also includes an annular permanent magnet 191 inside the non-magnetic ring 189, between the lamination rings 183 and 184, and between the solid-steel rings 186 and 187. The rotor 181 also includes an annular permanent magnet 192 inside the non-magnetic ring 190, between the lamination rings 184 and 185, and between the solid-steel rings 187 and 188. The annular permanent magnets 191 and 192 are magnetized in opposite directions along the central-rotation axis 141. The magnetization directions of the permanent magnets 191 and 192 as shown in FIG. 14 and in FIG. 15 are an example only, and the magnetization directions may be opposite or otherwise different in other embodiments. Further, alternative embodiments may include one or more electromagnets or other magnets additionally or alternatively to one or both of the permanent magnets 191 and 192.

More generally, the rotor 181 is an example only, and alternative embodiments may differ. For example, alternative embodiments may include more or fewer components, or one or more alternatives to the components described above. For example, an alternative embodiment may include materials that differ from the materials described above.

Still referring to FIG. 13, to FIG. 14, and to FIG. 15, the stator 182 includes four annular-sector stator bodies 193, 194, 195, and 196. The annular-sector stator bodies 194 and 196 are omitted from FIG. 13 for simplicity of illustration. The annular-sector stator body 193 includes SMC bodies 197 and an electric coil 198. The annular-sector stator body 194 includes SMC bodies 199 and an electric coil 200. The annular-sector stator body 195 includes SMC bodies 201 and an electric coil 202. The annular-sector stator body 196 includes SMC bodies 203 and an electric coil 204. The SMC bodies may be made from other materials, such as similar low-loss magnetic steels, sintered magnetic materials, or laminations, and alternative embodiments may have topologies that differ from the topology shown.

The lamination rings 183, 184, and 185 and the annular-sector stator bodies 193, 194, 195, and 196 may be sized and positioned such that a gap (which may be an air gap in some embodiments) is between the lamination rings 183, 184, and 185 and the annular-sector stator bodies 193, 194, 195, and 196. Such a gap may facilitate generation of magnetic forces as described herein, for example.

The electric coils 198, 200, 202, and 204 are electrically connected to the roll-stabilizer energy-storage device 110 (either directly or indirectly, such as indirectly through the roll-stabilizer controller 109) and may receive electric current from the roll-stabilizer energy-storage device 110 (shown in FIG. 1), and the roll-stabilizer controller 109 (also shown in FIG. 1) may control electric current through each of the electric coils 198, 200, 202, and 204 independently such that electric current through one of the electric coils 198, 200, 202, and 204 may be independent from electric current through one, more than one, or all of the others of the electric coils 198, 200, 202, and 204.

Referring to FIG. 16, the annular-sector stator body 193 is illustrated, and the annular-sector stator bodies 194, 195, and 196 may be similar to the annular-sector stator body 193. The electric coil 198 includes an electric conductor coiled around an axis 205 extending through and across the electric coil 198 the such that when an electric current passes through the electric coil 198 in a clockwise direction from the perspective of the central-rotation axis 141 (or clockwise in the orientation of FIG. 16), the electric coil 198 produces a magnetic field as shown by magnetic-field arrows 206 in FIG. 16, and when an electric current passes through the electric coil 198 in a counter-clockwise direction from the perspective of the central-rotation axis 141 (or counter-clockwise in the orientation of FIG. 16), the electric coil 198 produces a magnetic field opposite the magnetic-field arrows 206 in FIG. 16.

Referring back to FIG. 14 and to FIG. 15, the permanent magnet 191 creates a bias magnetic field as shown by magnetic-field arrows 207. The bias magnetic field as shown by the magnetic-field arrows 207 is generally toroidal (or generally rectangular in a cross-section along the the central-rotation axis 141) and passes through the permanent magnet 191, around the non-magnetic ring 189, through the lamination ring 184, around the electric coils 198, 200, 202, and 204, through the SMC bodies 197, 199, 201, and 203, through the lamination ring 183, and back through the permanent magnet 191. The solid-steel rings 186 and 187 may, in some embodiments, facilitate flow of magnetic flux, through the permanent magnet 191, from the bias magnetic field as shown by the magnetic-field arrows 207. The non-magnetic ring 189 may, in some embodiments, create a magnetic-flux barrier to shape the bias magnetic field as shown by the magnetic-field arrows 207.

Further, the permanent magnet 192 creates a bias magnetic field as shown by magnetic-field arrows 208. The bias magnetic field as shown by the magnetic-field arrows 208 is generally toroidal (or generally rectangular in a cross-section along the central-rotation axis 141, and opposite in direction to the bias magnetic field as shown by the magnetic-field arrows 207) and passes through the permanent magnet 192, around the non-magnetic ring 190, through the lamination ring 184, around the electric coils 198, 200, 202, and 204, through the SMC bodies 197, 199, 201, and 203, through the lamination ring 185, and back through the permanent magnet 192. The solid-steel rings 187 and 188 may, in some embodiments, facilitate flow of magnetic flux, through the permanent magnet 192, from the bias magnetic field as shown by the magnetic-field arrows 208. The non-magnetic ring 190 may, in some embodiments, create a magnetic-flux barrier to shape the bias magnetic field as shown by the magnetic-field arrows 208.

In general, the bias magnetic fields as shown by the magnetic-field arrows 207 and 208 create magnetic forces that are generally radial relative to the spin axis of rotation 128 and that attract the rotor 181 towards the stator 182 radially relative to the spin axis of rotation 128. Such attractive magnetic forces from the bias magnetic fields as shown by the magnetic-field arrows 207 and 208 may be uniform or similar around the spin axis of rotation 128, so the rotor 181 and the stator 182 therefore may function as a radial magnetic bearing (that may be known as a homopolar magnetic bearing) that may align the spin axis of rotation 128 to the central-rotation axis 141.

Referring to FIG. 14, to FIG. 15, and to FIG. 16, when an electric current passes through the electric coil 198 in a clockwise direction from the perspective of the central-rotation axis 141 (or clockwise in the orientation of FIG. 16), and when an electric current passes through the electric coil 202 in a counter-clockwise direction from the perspective of the central-rotation axis 141,
1. control magnetic fields as shown by magnetic-field arrows 209 and 210 pass around the electric coil 198, through the SMC bodies 197, through the lamination ring 183, through the SMC bodies 201, around the electric coil 202, through the lamination ring 184, and back around the electric coil 198, and
2. control magnetic fields as shown by magnetic-field arrows 211 and 212 pass around the electric coil 198, through the SMC bodies 197, through the lamination ring 185, through the SMC bodies 201, around the electric coil 202, through the lamination ring 184, and back around the electric coil 198.

As shown in FIG. 14, in the annular-sector stator body 193, the control magnetic fields as shown by the magnetic-field arrows 209 and 211 are in the same direction as the bias magnetic fields as shown by the magnetic-field arrows 207 and 208, so the control magnetic fields as shown by the magnetic-field arrows 209 and 211 complement or enhance the bias magnetic fields as shown by the magnetic-field arrows 207 and 208 in the annular-sector stator body 193 and strengthen the magnetic attraction of the rotor 181 towards the annular-sector stator body 193 of the stator 182.

As also shown in FIG. 14, in the annular-sector stator body 195, the control magnetic fields as shown by the magnetic-field arrows 209 and 211 are in an opposite direction from the bias magnetic fields as shown by the magnetic-field arrows 207 and 208, so the control magnetic fields as shown by the magnetic-field arrows 209 and 211 counter or diminish the bias magnetic fields as shown by the magnetic-field arrows 207 and 208 in the annular-sector stator body 195 and weaken the magnetic attraction of the rotor 181 towards the annular-sector stator body 195 of the stator 182.

As a result, when an electric current passes through the electric coil 198 in a clockwise direction from the perspective of the central-rotation axis 141 (or clockwise in the orientation of FIG. 16), and when an electric current passes through the electric coil 202 in a counter-clockwise direction from the perspective of the central-rotation axis 141, the electric coils 198 and 202 cause a net magnetic force 213 radially towards the annular-sector stator body 193, so the rotor 181 and the stator 182 therefore may function as an active radial magnetic bearing (that may be known as an e-core active radial magnetic bearing) having radial forces controllable at least in part by controlling electric currents through the electric coils 198 and 202.

If directions of the electric currents through the electric coils 198 and 202 are reversed from the directions described in the example above, then the electric currents would cause a net magnetic force opposite the net magnetic force 213 and radially towards the annular-sector stator body 195. Further, the example described above involves electric currents through the electric coils 198 and 202, but similar radial forces towards or away from the annular-sector stator bodies 194 and 196 may be controlled at least in part by controlling electric currents through the electric coils 200 and 204.

In general, diametrically opposed electric coils may cooperate to control radial magnetic forces. Therefore, in some embodiments, the electric coils 198 and 202 may be electrically connected to each other, the electric coils 200 and 204 may be electrically connected to each other, and the roll-stabilizer controller 109 (also shown in FIG. 1) may control electric current through the electric coils 198 and 202 independently from electric current through the electric coils 200 and 204.

In some embodiments, an e-core active radial magnetic bearing as described above may involve shorter paths for magnetic flux than other homopolar active magnetic bearings, so an e-core active radial magnetic bearing as described above may involve less material and be smaller than other homopolar active magnetic bearings.

The stator 182 is an example only, and alternative embodiments may differ. For example, an alternative embodiment may include more or fewer annular-sector stator bodies. Further, alternative embodiments may include more or fewer components, or one or more alternatives to the components described above. For example, an alternative embodiment may include materials that differ from the materials described above. As one example, alternative embodiments may include sets of laminations aligned in a radial direction instead of the SMC bodies. Also, an alternative embodiment may include more or fewer magnets than the embodiment described above.

### Axial Magnetic Bearing

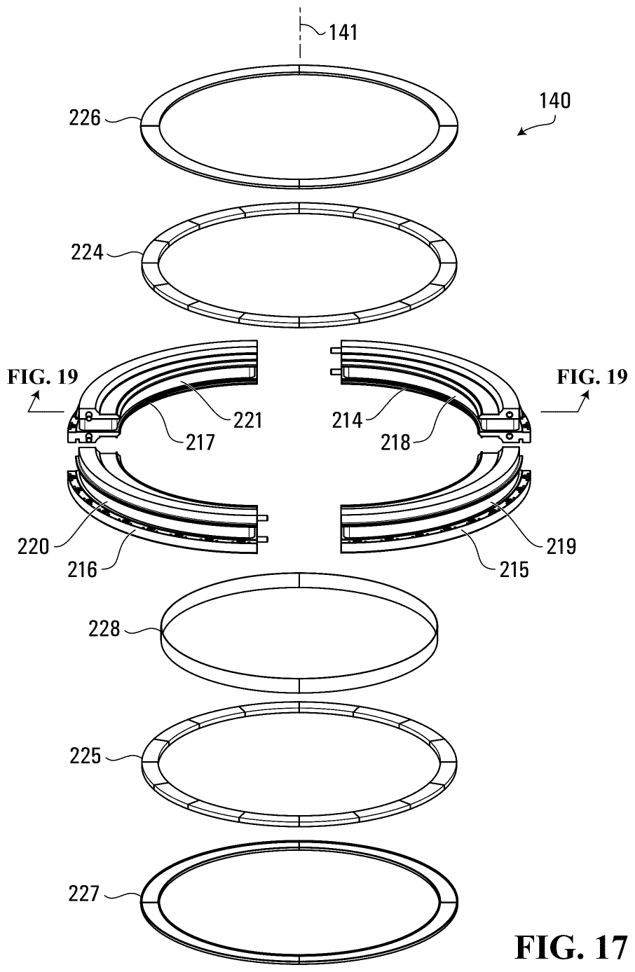

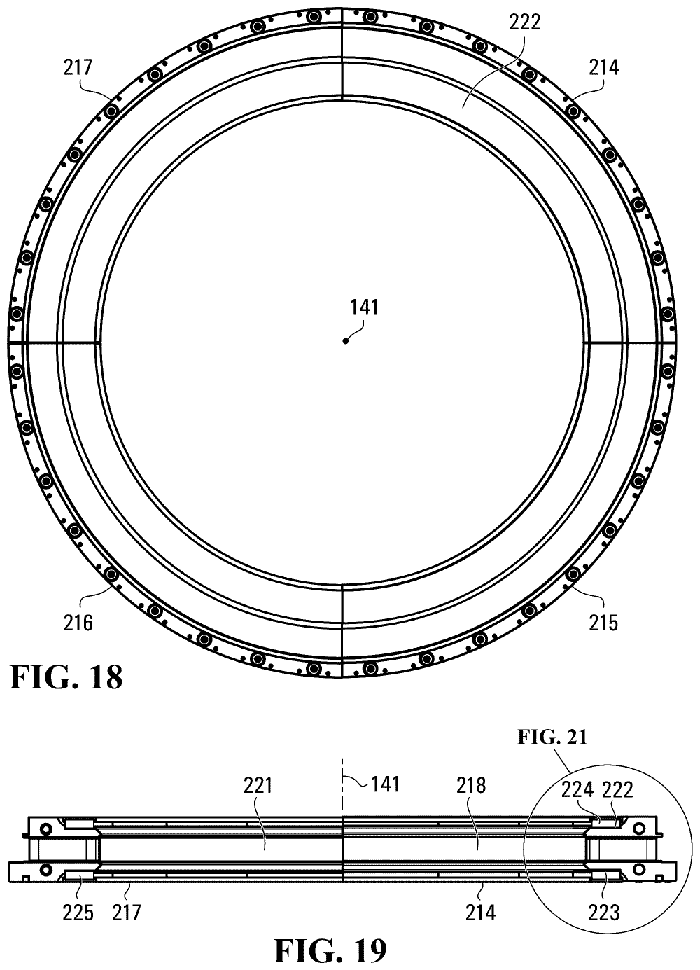

Referring to FIG. 17, the axial active magnetic bearing 140 includes four annular-sector bodies 214, 215, 216, and 217, which may be made from steel. When assembled as shown in FIGS. 18 and 19, the annular-sector bodies 214, 215, 216, and 217 collectively form an annular bearing body having a plurality of annular sectors surrounding the central-rotation axis 141. The sectors may be overlapping in some embodiments.

The annular-sector body 214 includes an electric coil 218. The electric coil 218 includes an electric conductor coiled around an axis parallel to the central-rotation axis 141 (or, more generally, extending transversely to the central-rotation axis 141) such that when an electric current passes through the electric coil, the electric coil magnetizes the annular-sector body 214 in a direction along such an axis parallel to the central-rotation axis 141. The annular-sector body 214 and the electric coil 218 thus function as an electromagnet positioned on the annular bearing body in one of the annular sectors of the annular bearing body.

The annular-sector body 215 includes an electric coil 219. The electric coil 219 includes an electric conductor coiled around an axis parallel to the central-rotation axis 141 (or, more generally, extending transversely to the central-rotation axis 141) such that when an electric current passes through the electric coil, the electric coil magnetizes the annular-sector body 215 in a direction along such an axis parallel to the central-rotation axis 141. The annular-sector body 215 and the electric coil 219 thus function as an electromagnet positioned on the annular bearing body in one of the annular sectors of the annular bearing body.

The annular-sector body 216 includes an electric coil 220. The electric coil 220 includes an electric conductor coiled around an axis parallel to the central-rotation axis 141 (or, more generally, extending transversely to the central-rotation axis 141) such that when an electric current passes through the electric coil, the electric coil magnetizes the annular-sector body 216 in a direction along such an axis parallel to the central-rotation axis 141. The annular-sector body 216 and the electric coil 220 thus function as an electromagnet positioned on the annular bearing body in one of the annular sectors of the annular bearing body.

The annular-sector body 217 includes an electric coil 221. The electric coil 221 includes an electric conductor coiled around an axis parallel to the central-rotation axis 141 (or, more generally, extending transversely to the central-rotation axis 141) such that when an electric current passes through the electric coil, the electric coil magnetizes the annular-sector body 217 in a direction along such an axis parallel to the central-rotation axis 141. The annular-sector body 217 and the electric coil 221 thus function as an electromagnet positioned on the annular bearing body in one of the annular sectors of the annular bearing body.

The electric coils 218, 219, 220, and 221 are electrically connected to the roll-stabilizer energy-storage device 110 (either directly or indirectly, such as indirectly through the roll-stabilizer controller 109) and may receive electric current from the roll-stabilizer energy-storage device 110 (shown in FIG. 1), and the roll-stabilizer controller 109 (also shown in FIG. 1) may control electric current through each of the electric coils 218, 219, 220, and 221 independently such that electric current through one of the electric coils 218, 219, 220, and 221 may be independent from electric current through one, more than one, or all of the others of the electric coils 218, 219, 220, and 221.

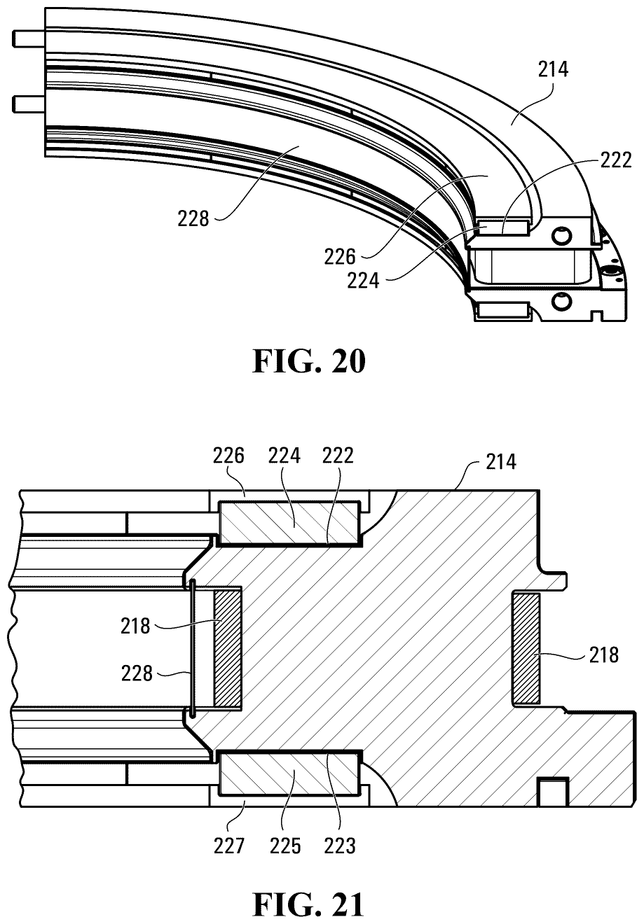

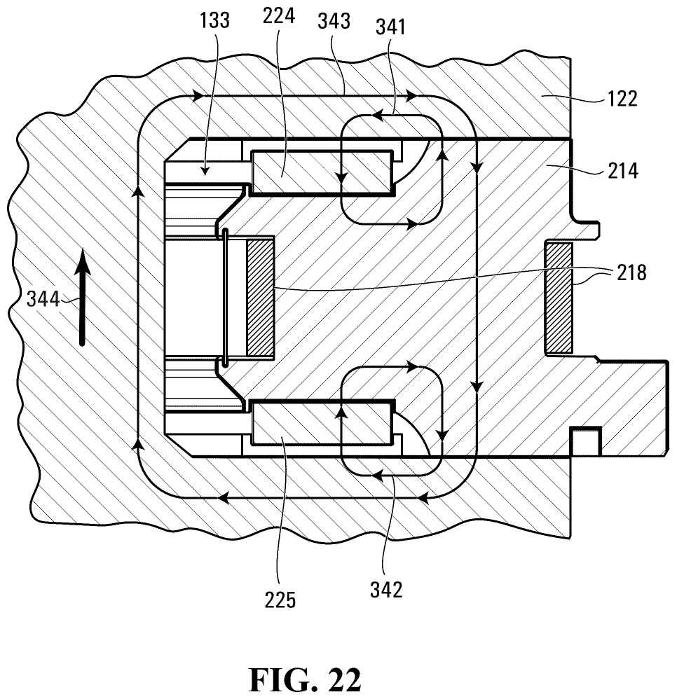

Referring to FIG. 20, to FIG. 21, and to FIG. 22, the annular-sector body 214 is illustrated, and the annular-sector bodies 215, 216, and 217 are similar to the annular-sector body 214. The annular-sector body 214 has an annular-sector surface 222 on one side, along an axis parallel to the central-rotation axis 141, of the electric coil 218, and an annular-sector surface 223 on an opposite side, along the axis parallel to the central-rotation axis 141, of the electric coil 218 from the annular-sector surface 222. An annular permanent magnet 224 may be positioned against annular-sector surfaces (such as the annular-sector surface 222) on one side of the electric coil 218 along an axis parallel to the central-rotation axis 141, and an annular permanent magnet 225 may be positioned against annular-sector surfaces (such as the annular-sector surface 223) on an opposite side of the electric coil 218 from the annular-sector surface 222 along the axis parallel to the central-rotation axis 141.

The annular permanent magnets 224 and 225 are magnetized in opposite directions along the central-rotation axis 141 (shown in FIG. 17) such that the annular permanent magnet 224 creates a bias magnetic field through the flywheel body 122 and through the annular-sector body 214 as shown by magnetic-field arrows 341 in FIG. 22, and the annular permanent magnet 225 creates a bias magnetic field through the flywheel body 122 and through the annular-sector body 214 as shown by magnetic-field arrows 342 in FIG. 22. Also, when an electric current passes through the electric coil 218, a control magnetic field as shown by magnetic-field arrows 343 in FIG. 22 passes through the flywheel body 122 and through the annular-sector body 214. As shown in FIG. 22, the control magnetic field as shown by the magnetic-field arrows 343 is in an opposite direction from the bias magnetic field as shown by the magnetic-field arrows 341 and in the same direction as the bias magnetic field as shown by the magnetic-field arrows 342, so the bias magnetic fields shown by magnetic-field arrows 342 and 343 and the control magnetic field as shown by the magnetic-field arrows 343 create a magnetic force 344 that is generally axial relative to the spin axis of rotation 128 and that attracts the rotor 123 upwards. However, alternative embodiments may include one or more electromagnets or other magnets additionally or alternatively to one or both of the permanent magnets 224 and 225. Further, the magnetization directions of the permanent magnets 224 and 225, and the control magnetic field as shown by the magnetic-field arrows 343, as shown in FIG. 22 are examples only, and the magnetization directions and magnetic fields may be opposite or otherwise different in other embodiments.

Referring to FIG. 17 and to FIG. 21, the axial active magnetic bearing 140 also includes a solid-steel ring 226 (which may be formed from four pieces as shown) on the annular permanent magnet 224 such that the annular permanent magnet 224 is between the annular-sector body 214 and the solid-steel ring 226. The axial active magnetic bearing 140 also includes a solid-steel ring 227 on the annular permanent magnet 225 such that the annular permanent magnet 225 is between the annular-sector body 214 and the solid-steel ring 227. The annular permanent magnets 224 and 225 may be segmented, which may create some discontinuities in magnetic flux density, so the solid-steel rings 226 and 227 may, in some embodiments, more uniformly distribute magnetic flux density between the annular-sector bodies 214, 215, 216, and 217 and the flywheel body 122. The axial active magnetic bearing 140 also includes a wire shield 228 between the electric coils 218, 219, 220, and 221 and the central-rotation axis 141 such that the wire shield 228 may retain and protect the electric coils 218, 219, 220, and 221.

Referring now to FIG. 22, when the roll-stabilizer apparatus 108 is assembled as shown in FIG. 3, at least a portion of the axial active magnetic bearing 140 may be positioned in the groove 133 so that magnetic fields produced by the axial active magnetic bearing 140 may exert axial forces on the flywheel body 122 to maintain the flywheel assembly 115 away from the touchdown bearings in the touchdown-bearing assemblies 125 and 126. In some embodiments, positioning the axial active magnetic bearing 140 in the groove 133 may permit a more-compact roll-stabilizer apparatus 108 when compared to other roll-stabilizer apparatuses having similar capacities for roll stabilization.

The groove 133, the solid-steel ring 226, and the annular-sector bodies 214, 215, 216, and 217 may be sized and positioned such that a gap (which may be an air gap in some embodiments) is between: the flywheel body 122 and the solid-steel ring 226; and the annular-sector bodies 214, 215, 216, and 217. Such a gap may facilitate generation of magnetic forces as described herein, for example.

The axial active magnetic bearing 140 is an example only, and alternative embodiments may differ. For example, the electromagnets of the axial active magnetic bearing 140 are in four annular sectors, but alternative embodiments may include more or fewer annular sectors. The number of sectors may be an even number in some embodiments. Further, in alternative embodiments, the annular sectors may not be equal to each other in size but rather may differ in size from each other. More generally, alternative embodiments may include more or fewer components, or one or more alternatives to the components described above. For example, an alternative embodiment may include materials that differ from the materials described above. Also, an alternative embodiment may include more or fewer magnets than the embodiment described above. Some alternative embodiments may include more than one axial magnet bearing, and may include stacks of axial magnetic bearings to increase axial force and/or torque output.

Torque from Axial Magnetic Bearing

In some embodiments, the axial active magnetic bearing 140 may apply a torque to the flywheel assembly 115, for example to complement a radial magnetic bearing including the rotor 123 and the stator 138, a radial magnetic bearing including the rotor 124 and the stator 139, or both, or more generally to function similarly to one or more radial bearings.

For example, one or more electric coils on a first side of the axial active magnetic bearing 140 may produce one or more magnetic fields that differ from one or more magnetic fields produced by one or more electric coils on a second side of the axial active magnetic bearing 140 opposite the first side of the axial active magnetic bearing 140. For example, one side of the axial active magnetic bearing 140 may include the electric coils 218 and 219, and an opposite side of the axial active magnetic bearing 140 may include the electric coils 220 and 221. As another example, one side of the axial active magnetic bearing 140 may include the electric coils 219 and 220, and an opposite side of the axial active magnetic bearing 140 may include the electric coils 218 and 221.

The one or more magnetic fields produced by the one or more electric coils on one side of the axial active magnetic bearing 140 may differ from the one or more magnetic fields produced by the one or more electric coils on an opposite side of the axial active magnetic bearing 140 in direction, in strength, or in both. Such different magnetic fields may cause the axial active magnetic bearing 140 to exert, in addition to any net axial force on the flywheel body 122, torque on the flywheel body 122 (and thus on the flywheel assembly 115) around an axis between the two sides of the axial active magnetic bearing 140 as described above, for example.

In some embodiments, because the axial active magnetic bearing 140 may apply a torque to the flywheel assembly 115, other radial bearings may be smaller, and the roll-stabilizer apparatus 108 may better control positions of the the flywheel assembly 115 in the flywheel-support body 113. For example, the roll-stabilizer apparatus 108 may experience significant external forces, and the axial active magnetic bearing 140 functioning as a radial bearing may, in some embodiments, allow the roll-stabilizer apparatus 108 to accommodate such external forces.

### Operation

Referring back to FIG. 1, to FIG. 2, and to FIG. 3, the roll-stabilizer assembly 107 may be attached to the hull 101 directly or indirectly such that the precession axis of rotation 119 is not parallel to the longitudinal axis 106. In some embodiments, the precession axis of rotation 119 may extend horizontally and perpendicular to the longitudinal axis 106, namely transversely relative to the hull 101. However, alternative embodiments may differ. For example, in some embodiments, the precession axis of rotation 119 may extend vertically or in another direction that is not parallel (and that may be perpendicular) to the longitudinal axis 106 of the marine vessel 100.

In operation, the electric motor/generator 142 may apply a torque to the flywheel assembly 115 (and thus to the flywheel body 122) around the spin axis of rotation 128 relative to the flywheel-support body 113, which may cause the flywheel assembly 115 to spin around the spin axis of rotation 128 relative to the flywheel-support body 113, thus causing the flywheel assembly 115 to have angular momentum along the spin axis of rotation 128.

When the flywheel assembly 115 is being prepared to spin, or is spinning, around the spin axis of rotation 128 relative to the flywheel-support body 113, the roll-stabilizer controller 109 may, in response to, at least, one or more signals indicating measurements of proximity or position of the flywheel assembly 115 in the flywheel-support body 113 from one or more proximity sensors, one or more position sensors, or both as described above, control electric currents through one or more of the electric coils 157, 164, 165, 166, 168, 169, 170, 171, 198, 200, 202, 204, 218, 219, 220, and 221, as described herein for example, to maintain the spin axis of rotation 128 along the central-rotation axis 141 (or along any other axis that may be desired as described below, for example) and to maintain the flywheel assembly 115 away from the touchdown bearings in the touchdown-bearing assemblies 125 and 126.

As indicated above, the rotor 123 and the stator 138 may function as a magnetic bearing. As also indicated above, the rotor 124 may be similar to the rotor 123, and the stator 139 may be similar to the stator 138. Therefore, the rotor 124 and the stator 139 may also function as a magnetic bearing. As also indicated above, the rotor 181 may be an alternative to the rotor 123, and the stator 182 may be an alternative to the stator 138, so the rotor 181 and the stator 182 may also function as a magnetic bearing. The axial active magnetic bearing 140 is also a magnetic bearing.

In some embodiments, such magnetic bearings may allow the flywheel assembly 115 to spin around the spin axis of rotation 128 relative to the flywheel-support body 113 with less friction when compared to other types of bearings. Such reduced friction may, in some embodiments, allow the flywheel assembly 115 to spin around the spin axis of rotation 128 relative to the flywheel-support body 113 with less power to the electric motor/generator 142 and with less cooling than a roll-stabilizer apparatus having other types of bearings. Further, in some embodiments, magnetic bearings such as those described herein may last longer than other bearings (such as mechanical bearings) and reduce or avoid cumbersome replacement of worn bearings. Also, in some embodiments, magnetic bearings such as those described herein may vibrate less and generate less noise than such other bearings, and may tolerate higher operating temperatures than such other bearings. Overall, the roll-stabilizer apparatus 108 may, in some embodiments, have a longer usable life or require less maintenance than a roll-stabilizer apparatus having other types of bearings.

Also, magnetic bearings such as those described herein may, in some embodiments, permit the flywheel assembly 115 to spin around the spin axis of rotation 128 relative to the flywheel-support body 113 faster than a roll-stabilizer apparatus having other types of bearings. Such faster spin of the flywheel assembly 115 around the spin axis of rotation 128 relative to the flywheel-support body 113 may, in some embodiments, permit, when compared to a roll-stabilizer apparatus having other types of bearings, greater angular momentum (and therefore greater capacity for roll stabilization) for the same mass of the flywheel assembly 115, or similar angular momentum (and therefore similar capacity for roll stabilization) for a reduced mass of the flywheel assembly 115. Therefore, the roll-stabilizer apparatus 108 may have a reduced mass compared to a roll-stabilizer apparatus having other types of bearings but similar capacity for roll stabilization.

When the roll-stabilizer apparatus 108 is not in operation, and in case such magnetic bearings are insufficient or fail for some reason, the touchdown bearings in the touchdown-bearing assemblies 125 and 126 may constrain movement of the flywheel assembly 115 relative to the flywheel-support body 113 to reduce or avoid any possible damage to the flywheel assembly 115 or to the flywheel-support body 113 from excessive movement of the flywheel assembly 115 relative to the flywheel-support body 113.

### Startup

In general, “startup” may refer to a process that involves controlling electric currents through electric coils to maintain the spin axis of rotation 128 along (namely colinear with, or close to but not necessarily colinear with) the central-rotation axis 141 and to maintain the flywheel assembly 115 away from the touchdown bearings in the touchdown-bearing assemblies 125 and 126, and that involves causing the flywheel assembly 115 (and thus the flywheel body 122) to spin around the spin axis of rotation 128 relative to the flywheel-support body 113 until the the flywheel assembly 115 reach a threshold minimum angular speed or angular momentum for roll stabilization.

In some embodiments, the remote device 112 may be used to initiate such startup by transmitting one or more wired, wireless, or other signals directly or indirectly to the roll-stabilizer controller 109 to indicate initiation of startup. For example, an application may be installed on the remote device 112 that causes remote device 112 to transmit one or more signals directly or indirectly to the roll-stabilizer controller 109. Startup may take some time because the flywheel assembly 115 may take some time to reach the threshold minimum angular speed or angular momentum for roll stabilization. Therefore, remote initiation may allow for remote initiation of startup, which may reduce or avoid time spent waiting for the flywheel assembly 115 to reach the threshold minimum angular speed or angular momentum for roll stabilization. Further, remote initiation may allow for a slower startup and thus reduced electrical power during startup.

### Remote Diagnostics

The remote device 112 may also receive one or more wired, wireless, or other signals directly or indirectly from the roll-stabilizer controller 109 to indicate diagnostic information regarding the roll-stabilizer assembly 107. Such diagnostic information may include, for example, operation status, a time when the flywheel assembly 115 (and thus the flywheel body 122) is predicted to reach a threshold minimum angular speed or angular momentum for roll stabilization, a battery charge or other condition of the roll-stabilizer energy-storage device 110, one or more indications of any faults, or a combination of two or more thereof. For example, an application may be installed on the remote device 112 that causes remote device 112 to indicate such diagnostic information in response to one or more wired, wireless, or other signals received by the remote device 112 directly or indirectly from the roll-stabilizer controller 109.

In some embodiments, such remote diagnostics may permit more-efficient maintenance or reductions in required maintenance, easier diagnosis by a manufacturer or maintenance provider, and possible remote maintenance to reduce or avoid time required for in-person maintenance.

### Energy Management

As indicated above, the electric motor/generator 142 is electrically connected to the roll-stabilizer energy-storage device 110, which is distinct from the main energy-storage device 105 in the embodiment shown (although alternative embodiments may differ). As also indicated above, the electric coils 157, 164, 165, 166, 168, 169, 170, 171, 198, 200, 202, 204, 218, 219, 220, and 221 are also electrically connected to the roll-stabilizer energy-storage device 110 (either directly or indirectly, such as indirectly through the roll-stabilizer controller 109) and may receive electric current from the roll-stabilizer energy-storage device 110. The electric energy used by the electric motor/generator 142 and by the electric coils 157, 164, 165, 166, 168, 169, 170, 171, 198, 200, 202, 204, 218, 219, 220, and 221 is used for roll stabilization. The electric motor/generator 142 may also provide electric energy to the roll-stabilizer controller 109 or to the inertial measurement unit 111 or otherwise provide electric energy for roll stabilization.

Therefore, energy stored by the roll-stabilizer energy-storage device 110 may be for roll stabilization. In some embodiments, energy stored by the roll-stabilizer energy-storage device 110 is only for one or more such roll-stabilization functions and unavailable for functions other than roll-stabilization, such as for a starter motor of the marine engine 104, for the marine engine 104 if the marine engine 104 includes an electric motor, or for other functions such as for navigation or lights, for example.

In some embodiments, the roll-stabilizer energy-storage device 110, distinct from the main energy-storage device 105, may reduce power draws on the main energy-storage device 105 when the electric motor/generator 142 is apply a torque to the flywheel assembly 115 (and thus to the flywheel body 122) around the spin axis of rotation 128 relative to the flywheel-support body 113.

Further, in some embodiments, the roll-stabilizer energy-storage device 110, distinct from the main energy-storage device 105, may provide greater electrical power than the main energy-storage device 105. In some embodiments, such greater electrical power may permit greater torque and therefore greater acceleration of flywheel assembly 115 (and thus to the flywheel body 122) around the spin axis of rotation 128 relative to the flywheel-support body 113, which may prepare the roll-stabilizer apparatus 108 for roll stabilization faster than other roll-stabilizer apparatuses that omit the roll-stabilizer energy-storage device 110.

Further, in some embodiments, the roll-stabilizer energy-storage device 110, distinct from the main energy-storage device 105, may facilitate recovery of rotational kinetic energy, from rotation of the flywheel assembly 115 (and thus from the flywheel body 122) around the spin axis of rotation 128 relative to the flywheel-support body 113, by converting such rotational kinetic energy to electrical energy and storing such electrical energy in the roll-stabilizer energy-storage device 110. Such recovery of rotational kinetic energy may be more difficult or impossible in other roll-stabilizer apparatuses that omit the roll-stabilizer energy-storage device 110. Further, such recovery of rotational kinetic energy may, in some embodiments, generate less heat than other roll-stabilizer apparatuses that omit the roll-stabilizer energy-storage device 110, so the roll-stabilizer apparatus 108 may require less cooling than a roll-stabilizer apparatus that does not recover of rotational kinetic energy.

### Eddy-Current Brake

As indicated above, the electric motor/generator 142 may convert rotational kinetic energy, from rotation of the flywheel assembly 115 (and thus from the flywheel body 122) around the spin axis of rotation 128 relative to the flywheel-support body 113, to electrical energy, and the electric motor/generator 142 may therefore function as a brake.

However, in some situations, further braking forces may be desired. In such cases, the roll-stabilizer controller 109 may cause at least some of the electric coils 218, 219, 220, and 221 (shown in FIG. 17) to produce different magnetic fields, for example by causing respective electric currents through at least some of the electric coils 218, 219, 220, and 221 to differ.

For example, the roll-stabilizer controller 109 may cause the electric coils 218 and 220 to produce magnetic fields in a first direction along an axis parallel to the central-rotation axis 141 while causing the electric coils 219 and 221 to produce magnetic fields in a second direction opposite the first direction along the axis parallel to the central-rotation axis 141. As another example, the roll-stabilizer controller 109 may cause the electric coils 218 and 220 to produce magnetic fields having a first strength while causing the electric coils 219 and 221 to produce magnetic fields having a second strength different from the first strength. In some embodiments, magnetic fields produced by some or all of the electric coils 218, 219, 220, and 221 may, in a direction around the central-rotation axis 141, alternate between two different types of magnetic fields. For example, magnetic fields produced by some or all of the electric coils 218, 219, 220, and 221 may, in a direction around the central-rotation axis 141, alternate between different directions, different strengths, or both.

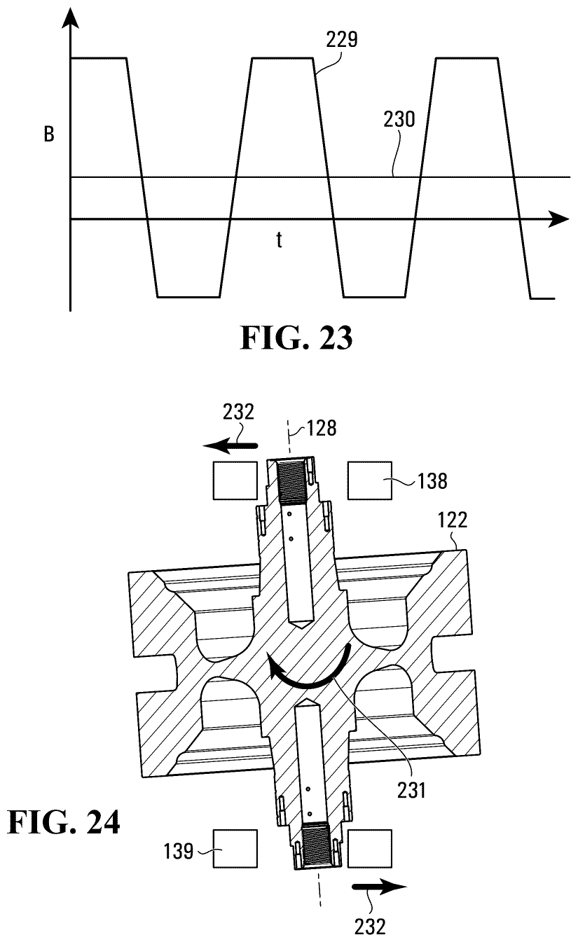

When the flywheel body 122 is rotating around the spin axis of rotation 128 relative to the flywheel-support body 113, and when the roll-stabilizer controller 109 causes at least some of the electric coils 218, 219, 220, and 221 to produce different magnetic fields, a point on the flywheel body 122 may experience changes in magnetic field over time. In FIG. 23, a line 229 illustrates an example of changes over time (indicated by t in FIG. 23) in magnetic field (indicated by B in FIG. 23) experienced by a point on the flywheel body 122 when the flywheel body 122 is rotating around the spin axis of rotation 128 relative to the flywheel-support body 113 and when the roll-stabilizer controller 109 causes at least some of the electric coils 218, 219, 220, and 221 to produce different magnetic fields, and a line 230 illustrates an average magnetic field over a period of time when the flywheel body 122 is rotating around the spin axis of rotation 128 relative to the flywheel-support body 113 and when the roll-stabilizer controller 109 causes at least some of the electric coils 218, 219, 220, and 221 to produce different magnetic fields.

Such changes over time in magnetic field, as illustrated by the line 229 for example, may induce eddy currents in the flywheel body 122, which may result in a torque on the flywheel body 122 (and thus on the flywheel assembly 115) in a direction opposite a direction of rotation of the flywheel body 122 is rotating around the spin axis of rotation 128 relative to the flywheel-support body 113. Therefore, by causing at least some of the electric coils 218, 219, 220, and 221 to produce different magnetic fields, the roll-stabilizer controller 109 may cause the axial active magnetic bearing 140 to function as an eddy-current brake.

Such an eddy-current brake may, in some embodiments, allow for fast braking when desired. Also, such an eddy-current brake may, in some embodiments, reduce or avoid wear on physical brakes, or allow physical brakes to be reduced in size, simplified, or avoided altogether. Also, in some embodiments, heat generated from such an eddy-current brake may be absorbed by the flywheel body 122, which may be able to accommodate such heat better than other components of the roll-stabilizer apparatus 108.

### Movement Estimation and Prediction

As indicated above, measurements of linear acceleration, of rotational acceleration, of orientation, or a combination of two or more thereof, relative to an inertial frame of reference or another frame of reference, of the hull 101 by the inertial measurement unit 111 may indicate such acceleration, orientation, or both of the mounting body 114 relative to such a frame of reference. In some embodiments, the roll-stabilizer controller 109 may estimate, predict, or both movement of the hull 101, of the mounting body 114, of one or more other locations on the marine vessel 100, or of a combination of two or more thereof, relative to an inertial frame of reference or another frame of reference, for example in response to, at least, one or more signals indicating measurements (by the inertial measurement unit 111 shown in FIG. 1, for example) of linear acceleration, of rotational acceleration, of orientation, or of two or more thereof of the hull 101 relative to such a frame of reference. In some embodiments, such movement estimation, movement prediction, or both may involve an open-loop system of the roll-stabilizer controller 109, at least one predictive model of the roll-stabilizer controller 109, a time history of measurements, or two or more thereof, for example. For example, such prediction or estimation may involve analysis or consideration of measurements of acceleration, velocity, or both by the inertial measurement unit 111.

For example, in response to, at least, one or more signals indicating measurements by the inertial measurement unit 111, the roll-stabilizer controller 109 may detect periodic movement (for example, from waves causing roll of the hull 101) of the hull 101, of the mounting body 114, of one or more other locations on the marine vessel 100, or of a combination of two or more thereof, relative to an inertial frame of reference or another frame of reference, and predicted movement may be movement of the hull 101, of the mounting body 114, of one or more other locations on the marine vessel 100, or of a combination of two or more thereof, relative to such a frame of reference and according to such detected periodic movement. Such movement may include roll of the hull 101 around the longitudinal axis 106 or other movement such as linear or other rotational movement, and such movement may not necessarily be periodic.

In general, movement of the hull 101, of the mounting body 114, of one or more other locations on the marine vessel 100, relative to an inertial frame of reference or another frame of reference, may cause precession of the flywheel assembly 115 relative to the flywheel-support body 113 and relative to the mounting body 114. Therefore, when the roll-stabilizer controller 109 predicts movement of the hull 101, of the mounting body 114, of one or more other locations on the marine vessel 100, or of a combination of two or more thereof, relative to an inertial frame of reference or another frame of reference, the roll-stabilizer controller 109 may also predict resulting precession of the flywheel assembly 115 relative to the flywheel-support body 113 and relative to the mounting body 114 in a predicted direction of precession.

Alternative embodiments may differ and may, for example, estimate or predict movement of the hull 101, of the mounting body 114, of one or more other locations on the marine vessel 100, or of a combination of two or more thereof in other ways. For example, in some embodiments, movement of the hull 101, of the mounting body 114, of one or more other locations on the marine vessel 100, or of a combination of two or more thereof may be estimated or predicted using one or more measurements, relative to an inertial frame of reference or another frame of reference, of linear acceleration, of rotational acceleration, of orientation, or a combination of two or more thereof of the flywheel-support body 113.

### Flywheel Force, Torque, or Movement in Response to Predicted Movement

As indicated above, the roll-stabilizer controller 109 may, in response to, at least, one or more signals indicating measurements of proximity or position of the flywheel assembly 115 in the flywheel-support body 113 from one or more proximity sensors, one or more position sensors, or both as described above, control electric currents through one or more of the electric coils 157, 164, 165, 166, 168, 169, 170, 171, 198, 200, 202, 204, 218, 219, 220, and 221, as described herein for example, to maintain the spin axis of rotation 128 along a target axis, which may be colinear with the central-rotation axis 141 or close to but not necessarily colinear with the central-rotation axis 141, and to maintain the flywheel assembly 115 away from the touchdown bearings in the touchdown-bearing assemblies 125 and 126. However, in some embodiments, the roll-stabilizer controller 109 may control electric currents through one or more of the electric coils 157, 164, 165, 166, 168, 169, 170, 171, 198, 200, 202, 204, 218, 219, 220, and 221 in response to other measurements, detections, or predictions, such as acceleration, velocity, or both of the flywheel-support body 113 relative to inertial ground as measured by an inertial measurement unit similar to the inertial measurement unit 111, for example.

In general, movement of the hull 101, of the mounting body 114, of one or more other locations on the marine vessel 100, or of a combination of two or more thereof, relative to an inertial frame of reference or another frame of reference, may cause the flywheel-support body 113 to move relative to the flywheel assembly 115 in a direction of such movement. Therefore, in some embodiments, in response to, at least, predicting predicted movement of the hull 101, of the mounting body 114, of one or more other locations on the marine vessel 100, or of a combination of two or more thereof in a predicted direction relative to an inertial frame of reference or another frame of reference, the roll-stabilizer controller 109 may control electric currents through one or more of the electric coils 157, 164, 165, 166, 168, 169, 170, 171, 198, 200, 202, 204, 218, 219, 220, and 221 to cause at least one magnetic bearing to exert one or more forces, one or more torques, or both on, or to move, the flywheel assembly 115 (and thus the flywheel body 122) generally in the predicted direction of movement (for example, in the predicted direction of movement or in a direction close to the predicted direction of movement) relative to the flywheel-support body 113, for example to maintain the spin axis of rotation 128 along (namely colinear with, or close to but not necessarily colinear with) the central-rotation axis 141 and to maintain the flywheel assembly 115 away from the touchdown bearings in the touchdown-bearing assemblies 125 and 126. In some embodiments, the roll-stabilizer controller 109 may do so independently of any measurement of position of the flywheel assembly 115 or of the flywheel body 122 relative to the flywheel-support body 113.

Also, in general, rotation of the flywheel assembly 115 (and thus of the flywheel body 122), relative to an inertial frame of reference or another frame of reference, may cause the flywheel assembly 115 (and thus of the flywheel body 122) to move in a direction of precession relative to the flywheel-support body 113 and relative to the mounting body 114. Therefore, in some embodiments, in response to, at least, predicting predicted precession of the flywheel assembly 115 (and thus of the flywheel body 122) relative to the flywheel-support body 113 and relative to the mounting body 114 in a predicted direction of precession, the roll-stabilizer controller 109 may control electric currents through one or more of the electric coils 157, 164, 165, 166, 168, 169, 170, 171, 198, 200, 202, 204, 218, 219, 220, and 221 to cause at least one magnetic bearing to exert one or more forces, one or more torques, or both on, or to move, the flywheel assembly 115 (and thus the flywheel body 122) generally opposite the predicted direction of precession (for example, opposite the predicted direction of precession or in a direction close to opposite the predicted direction of precession) relative to the flywheel-support body 113 to maintain the spin axis of rotation 128 along (namely colinear with, or close to but not necessarily colinear with) the central-rotation axis 141 and to maintain the flywheel assembly 115 away from the touchdown bearings in the touchdown-bearing assemblies 125 and 126. In some embodiments, the roll-stabilizer controller 109 may do so independently of any measurement of position of the flywheel assembly 115 or of the flywheel body 122 relative to the flywheel-support body 113.

In some embodiments, such flywheel movement in response to predicted movement, predicted precession, or both may reduce undesired physical contact between the flywheel assembly 115 and the flywheel-support body 113.

### Negative Stiffness

Referring back to FIG. 3, to FIG. 10, to FIG. 11, and to FIG. 12, if the rotor 123 moves in a radial direction relative to the stator 138 such that the spin axis of rotation 128 is not along the central-rotation axis 141 within the rotor 123 and the stator 138, then magnetic forces created by the bias magnetic fields as shown by the magnetic-field arrows 144 are stronger on a side of the rotor 123 that is closer to the stator 138 and are weaker on a side of the rotor 123 that is farther from the stator 138, so magnetic forces will tend to attract the rotor 123 to the stator 138 towards the side of the rotor 123 that is closer to the stator 138.

The rotor 123 and the stator 138 are part of an example shown in FIG. 3, in FIG. 10, in FIG. 11, and in FIG. 12, but likewise if the rotor 124 moves in a radial direction relative to the stator 139 such that the spin axis of rotation 128 is not along the central-rotation axis 141 within the rotor 124 and the stator 139, magnetic forces will tend to attract the rotor 124 to the stator 139 towards the side of the rotor 124 that is closer to the stator 139. Likewise, if the rotor 181 moves in a radial direction relative to the stator 182 such that the spin axis of rotation 128 is not along the central-rotation axis 141 within the rotor 181 and the stator 182, magnetic forces will tend to attract the rotor 181 to the stator 182 towards the side of the rotor 181 that is closer to the stator 182.

Such tendencies may be referred to as “negative stiffness”, which may cause undesired contact between a rotor and a stator, or undesired misalignment of a rotor relative to a stator. However, in some embodiments, negative stiffness may facilitate alignment of the rotor 123 and the stator 138, alignment of the rotor 124 and the stator 139, alignment of the rotor 181 and the stator 182, or two or more thereof.

As indicated above, in some embodiments, in response to, at least, predicting the predicted movement of the mounting body 114, the roll-stabilizer controller 109 may control electric currents through one or more of the electric coils 157, 164, 165, 166, 168, 169, 170, 171, 198, 200, 202, 204, 218, 219, 220, and 221 to cause the at least one magnetic bearing to move the flywheel assembly 115 (and thus the flywheel body 122) in the predicted direction of movement, in the predicted direction of precession, or both relative to the flywheel-support body 113 to maintain the spin axis of rotation 128 along the central-rotation axis 141 and to maintain the flywheel assembly 115 away from the touchdown bearings in the touchdown-bearing assemblies 125 and 126. In some embodiments, the roll-stabilizer controller 109 may do so in response to predicted magnetic forces that result from such movement.

For example, referring to FIG. 24, the roll-stabilizer controller 109 may predict movement of the flywheel assembly 115 or of the flywheel body 122 relative to the flywheel-support body 113 in a predicted direction 231 different from a direction around the spin axis of rotation 128. In the example of FIG. 24, in response predicting predicted movement of the flywheel body 122 relative to the flywheel-support body 113 in the predicted direction 231, the roll-stabilizer controller 109 may cause at least one radial magnetic bearing (such as a radial magnetic bearing including the rotor 123 and the stator 138, a radial magnetic bearing including the rotor 124 and the stator 139, or both) to rotate the flywheel assembly 115 (and thus the flywheel body 122) relative to the flywheel-support body 113 in a direction as shown by arrows 232 and opposite the predicted direction 231 such that the flywheel body 122 is farther from the at least one radial magnetic bearing in the predicted direction than in a direction opposite the predicted direction 231.

Rotation of the flywheel assembly 115 (and thus the flywheel body 122) relative to the flywheel-support body 113 in the direction as shown by the arrows 232 may cause negative stiffness because magnetic forces in the radial magnetic bearings may tend to cause the flywheel assembly 115 (and thus the flywheel body 122) to rotate further relative to the flywheel-support body 113 in the direction as shown by the arrows 232. However, such negative stiffness may resist the predicted movement of the flywheel body 122 relative to the flywheel-support body 113 in the predicted direction 231 such that the radial magnetic bearings require less electric current, may be smaller, or may be simpler than would be required to resist the predicted movement of the flywheel body 122 relative to the flywheel-support body 113 in the predicted direction 231 without such negative stiffness.

In some embodiments, such negative stiffness may result from moving the flywheel assembly 115 (and thus the flywheel body 122) relative to the flywheel-support body 113
1. generally in a predicted direction of motion of the flywheel-support body 113, and
2. generally in a direction opposite a predicted direction of precession of the flywheel assembly 115 (and thus the flywheel body 122) relative to the flywheel-support body 113.

In some embodiments, negative stiffness as described above may facilitate alignment of the flywheel body 122 because the magnetic forces caused by the resulting negative stiffness may tend to resist the predicted movement of the flywheel assembly 115 (and thus of the flywheel body 122) relative to the flywheel-support body 113 and require less electric current through one or more of the electric coils 157, 164, 165, 166, 168, 169, 170, 171, 198, 200, 202, 204, 218, 219, 220, and 221 to control positions of the the flywheel assembly 115 relative to the flywheel-support body 113. Such a reduction in electric current may, in some embodiments, conserve energy and also reduce generation of heat in the roll-stabilizer apparatus 108. Further, such use of negative stiffness may, in some embodiments, permit smaller or simpler magnetic bearings than would be required in a roll-stabilizer apparatus that does not use of negative stiffness as described above, for example.

In the example of FIG. 24, the predicted direction 231 is a rotational direction and the arrows 232 also indicate a rotational direction. However, alternative embodiments may differ, and for example the predicted direction may be linear or a combination of rotational and linear.

### Active Actuation

Referring back to FIG. 4, as indicated above, each of the precession-control devices 120 and 121 is operable to apply a torque to, and to rotate, the mounting bracket 118 (and thus the flywheel-support body 113) around the precession axis of rotation 119 relative to the base 116 in response to, at least, one or more control signals from the roll-stabilizer controller 109.

In some embodiments, the roll-stabilizer controller 109 may cause such rotation of the mounting bracket 118 around the precession axis of rotation 119 relative to the base 116 to counteract detected or predicted roll of the marine vessel 100 around the longitudinal axis 106, or for other reasons.

For example, the roll-stabilizer controller 109 may cause such rotation of the mounting bracket 118 around the precession axis of rotation 119 relative to the base 116 to facilitate identification of a roll factor of the marine vessel 100, and the roll-stabilizer controller 109 may use such a roll factor of the marine vessel 100 to determine how to control rotation of the mounting bracket 118 around the precession axis of rotation 119 relative to the base 116 to counteract detected or predicted roll of the marine vessel 100 around the longitudinal axis 106.

As another example, the roll-stabilizer controller 109 may cause such rotation of the mounting bracket 118 around the precession axis of rotation 119 relative to the base 116 to cause desired roll of the marine vessel 100 around the longitudinal axis 106.

### Internally Supported Flywheel Body

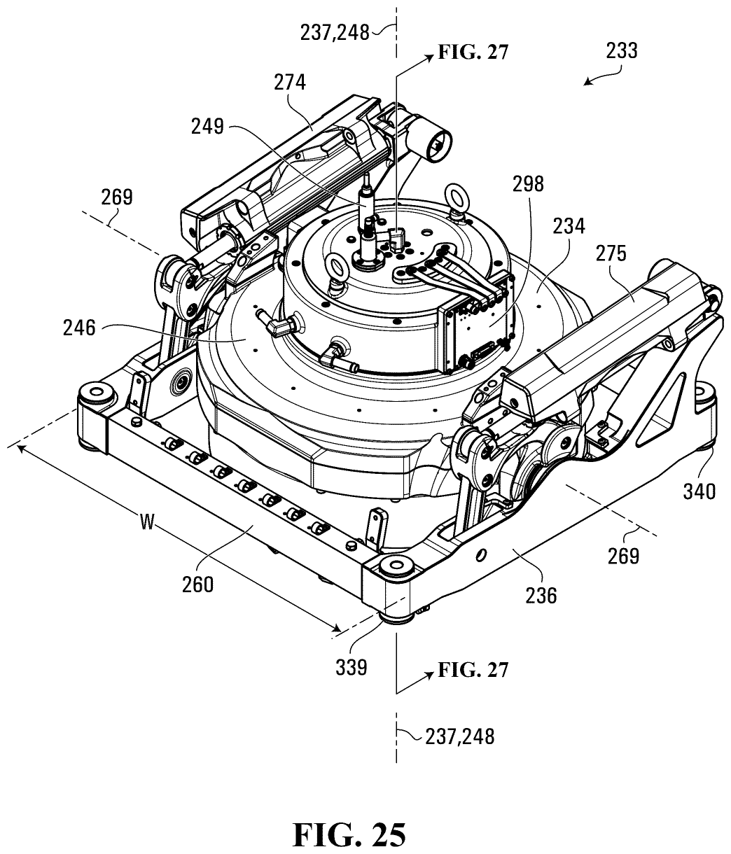

Referring now to FIGS. 25, 26, and 27, a roll-stabilizer apparatus according to another embodiment is shown generally at 233 and includes a flywheel-support body 234, a flywheel body 235 inside the flywheel-support body 234, and a mounting body 236. The roll-stabilizer apparatus 233 may be used, for example, in place of the roll-stabilizer apparatus 108 in the roll-stabilizer assembly 107 of the marine vessel 100, and may be controlled by the roll-stabilizer controller 109 as described above with respect to the roll-stabilizer apparatus 108.

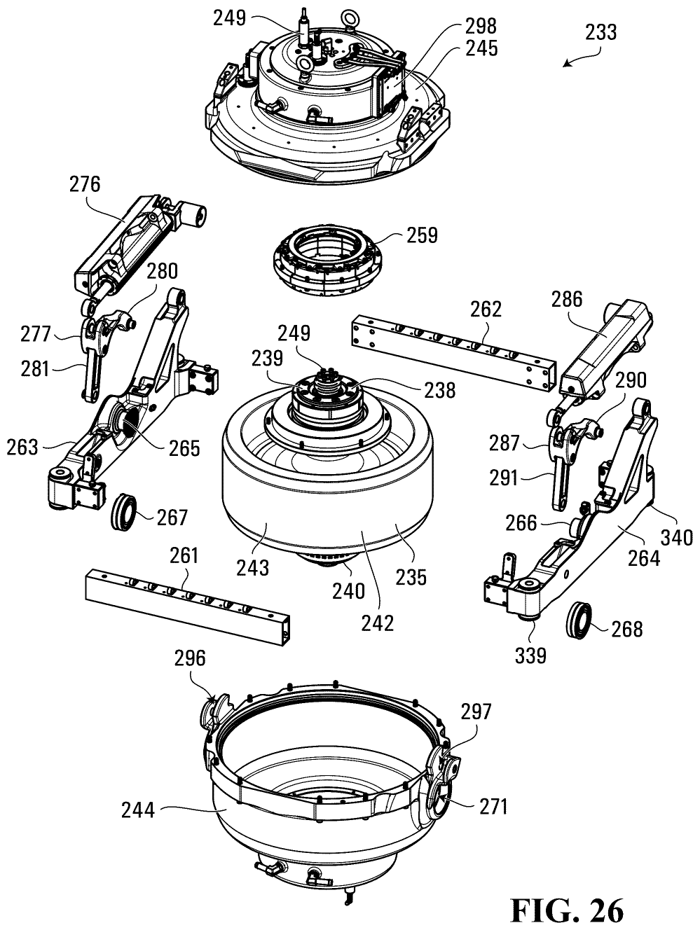

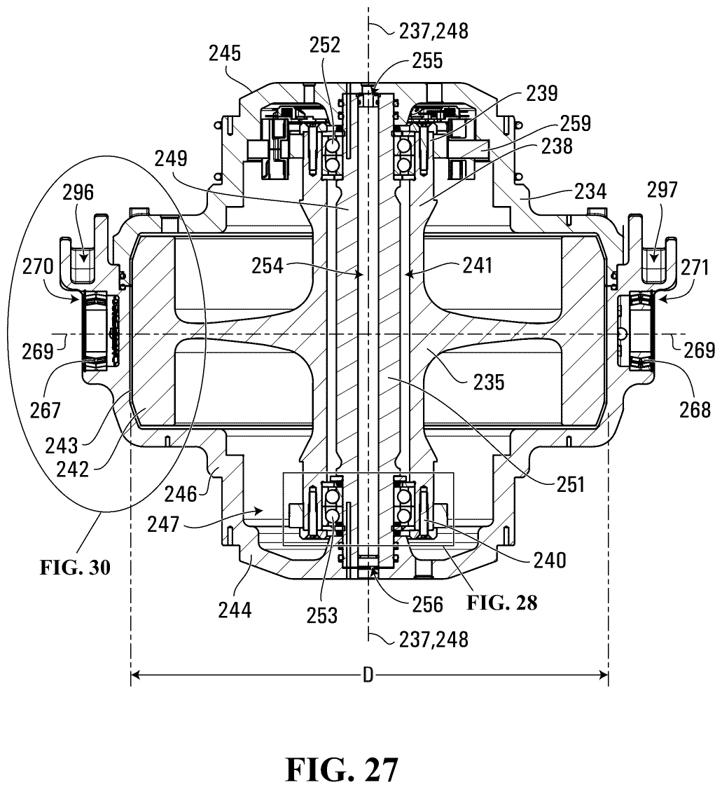

Referring to FIGS. 26 and 27, the flywheel body 235 is generally symmetrical about a spin axis of rotation 237, and includes a shaft 238 extending along the spin axis of rotation 237 between a first end, shown generally at 239, and a second end, shown generally at 240, of the shaft 238. The spin axis of rotation 237 may be through a center of mass of the flywheel body 235 and through centers of the first and second ends 239 and 240, although the flywheel body does not necessarily have to spin around the spin axis of rotation 237. The shaft 238 defines an axial through hole, shown generally at 241, extending along the spin axis of rotation 237 from the first end 239 to the second end 240. However, alternative embodiments may differ. For example, a shaft of an alternative embodiment may define an axial hole that extends along only part of a distance between a first end and a second end of the shaft, such as from the first end to a midpoint of the shaft. In other alternative embodiments, the shaft may include more than one axial hole, such as a first axial hole extending inward from the first end and a second axial hole extending inward from the second end.

The flywheel body 235 also includes a wheel portion 242 surrounding the shaft 238 and the spin axis of rotation 237. Much of the wheel portion 242 is spaced apart from the spin axis of rotation 237 to increase a moment of inertia of the flywheel body 235. An outer (or outermost) peripheral surface 243 of the wheel portion 242 also surrounds the shaft 238 and the spin axis of rotation 237, and is generally cylindrical around the spin axis of rotation 237. However, alternative embodiments may differ. For example, a wheel portion of an alternative embodiment may include a groove such as the groove 133 of the wheel portion 131 of the flywheel body 122, or may include a groove in a peripheral surface that is not necessarily an outer or outermost peripheral surface of the wheel portion, and that may be an inner surface of a flywheel body, for example.

Referring to FIGS. 25, 26, and 27, the flywheel-support body 234 includes housing bodies 244 and 245 that, when assembled as shown in FIG. 25 and in FIG. 27, form a housing 246 that defines an internal cavity, shown generally at 247. In some embodiments, the flywheel-support body 234 may include a central-rotation axis 248, which may extend through a center of the housing body 244 and a center of the housing body 245 when the housing bodies 244 and 245 are assembled to form the housing 246, and which may be colinear with the spin axis of rotation 237 of the flywheel body 235. As with the central-rotation axis 141 of the flywheel-support body 113 of the roll-stabilizer apparatus 108, the central-rotation axis 248 of the flywheel-support body 234 is not necessarily at an exact center of the housing body 244, the housing body 245, the flywheel-support body 234, or of any other structure. Of course, the embodiment shown is an example only, and alternative embodiments may vary. For example, alternative embodiments may include a different number of housing bodies forming the housing 246.

The housing 246 surrounds and houses the flywheel body 235 within the internal cavity 247. That is, the flywheel body 235 is located entirely within the internal cavity 247. The housing 246 may form a seal around the internal cavity 247 to enable the internal cavity 247 to contain an internal environment different than an ambient external environment. For example, the seal may be an air-tight seal, and the internal environment may have a different pressure than ambient pressure, or may contain gases or mixtures of gases different than ambient air. Thus, for example, the housing 246 may enclose the flywheel body 235 in an environment that has a pressure lower than ambient pressure, such as a vacuum, or that includes a slippery gas, helium, or some other gas or mixture of gases. In the embodiment shown, the flywheel-support body 234 includes valves, such as valve 249, which are in fluid communication with the internal cavity 247. The valve 249 is operable to control movement of gases into or out of the internal cavity 247. For example, the valve 249 may be operable to evacuate the internal cavity 247 to generate an environment having a pressure lower than ambient pressure.

The flywheel-support body 234 also includes a rotation-support body 250 extending from the center of the housing body 244 to the center of the housing body 245 within the internal cavity 247 when the housing bodies 244 and 245 are assembled to form the housing 246. The rotation-support body 250 is generally centered along the spin axis of rotation 237 of the flywheel body 235 (and/or the central-rotation axis 248 of the flywheel-support body 234) and extends through the axial through hole 241 of the flywheel body 235, such that an enclosed portion 251 of the rotation-support body 250 is positioned through the axial through hole 241. That is, the flywheel body 235 surrounds the enclosed portion 251 of the rotation-support body 250. In the embodiment shown, the flywheel-support body 234 also includes bearings 252 and 253 disposed along the enclosed portion 251 of the rotation-support body 250 within the axial through hole 241 of the flywheel body 235. The bearings 252 and 253 interface with the flywheel body 235 and are operable to support rotation of the flywheel body 235 relative to the rotation-support body 250, as well as axial loads between the flywheel body 235 and the rotation-support body 250. More specifically, the bearings 252 and 253 are operable to support the flywheel body 235 on the rotation-support body 250 such that the flywheel body 235 is rotatable within and relative to the flywheel-support body 234 around the spin axis of rotation 237, and such that the flywheel body 235 is maintained aligned with the flywheel-support body 234. In the embodiment shown, the bearings 252 and 253 and the rotation-support body 250 generally maintain the the flywheel body 235 positioned relative to the flywheel-support body 234 such that the spin axis of rotation 237 of the flywheel body 235 is colinear with the central-rotation axis 248 of the flywheel-support body 234. This configuration can facilitate assembly, as it allows many rotating elements of the roll-stabilizer apparatus 233 (e.g., the flywheel body 235, the bearings 252 and 253, and the rotation-support body 250) to be assembled outside of the housing 246, thus eliminating a requirement for precision alignment of the housing bodies 244 and 245. Of course, the embodiment shown is an example only, and alternative embodiments may vary. For example, alternative embodiments may include a rotation-support body extending through only a part of the axial through hole 241, or may include more than one rotation-support body.

In the embodiment shown, the rotation-support body 250 defines an internal fluid conduit shown generally at 254. The internal fluid conduit 254 extends through an entirety of the rotation-support body 250 along the spin axis of rotation 237 and includes a first opening 255 where the rotation-support body 250 interfaces with the housing body 244 and a second opening 256 where the rotation-support body 250 interfaces with the housing body 245. The internal fluid conduit 254 is operable to convey a fluid through the rotation-support body 250 between the first opening 255 and the second opening 256. In some embodiments, the roll-stabilizer apparatus 233 may also include a fluid reservoir (not shown) fluidly connected to the internal fluid conduit 254, and a fluid pump (not shown) fluidly connected to both internal fluid conduit 254 and the fluid reservoir and operable to pump the fluid from the fluid reservoir to the internal fluid conduit 254. In some embodiments, the fluid conveyed through the internal fluid conduit 254 may be a coolant, and the internal fluid conduit 254, fluid reservoir, and fluid pump may function as a cooling system operable to cool the bearings 252 and 253. Such a cooling system may be used in conjunction with a heat exchanger and a separate cooling circuit.

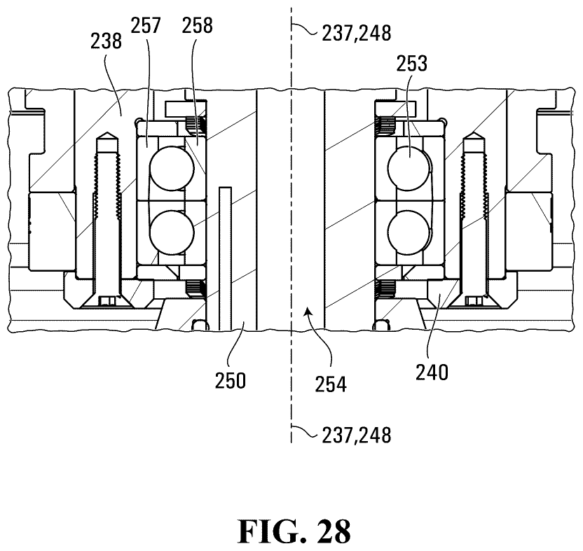

Referring now to FIGS. 27 and 28, the bearings 252 and 253 in the embodiment shown are mechanical bearings. More specifically, the bearings 252 and 253 are ball bearings. Considering as an example the bearing 253 as shown in greater detail in FIG. 28, the bearing 253 includes an outer race 257 and an inner race 258. The outer race 257 is fixed to the shaft 238 of the flywheel body 235, while the inner race 258 interfaces with the rotation-support body 250. In some embodiments, the inner race 258 may be fixed to the rotation-support body 250. However, in other embodiments, the inner race 258 may be a “floating” inner race, movable axially along the rotation-support body 250 (i.e., along the central-rotation axis 248 of the flywheel-support body 234). A “floating” inner race may be required to accommodate thermal expansion in some embodiments. The outer race 257 is operable to rotate relative to the inner race 258 and relative to the rotation-support body 250 and thus the flywheel-support body 234. As such, each of the bearings 252 and 253 includes an outer body (i.e., the outer race 257 of the bearing 253) that is rotatable relative to the flywheel-support body 234, and rotation of these outer bodies enables the flywheel body 235 to rotate relative to the flywheel-support body 234. In some embodiments, a majority of the heat generated in the bearings 252 and 253, such as about ⅔, for example, of the heat generated in the bearings 252 and 253, may be generated in inner races of the bearings 252 and 253, such as the inner race 258 of the bearing 253. Because these inner races are fixed to (i.e., in contact with) the rotation-support body 250, in embodiments where the internal fluid conduit 254, fluid reservoir, and fluid pump function as a cooling system operable to cool the bearings 252 and 253 as described above, cooling of the bearings 252 and 253 may be improved due to direct cooling of the inner races through conduction. Such improved cooling may increase an operating life of the bearings 252 and 253. Of course, the embodiment shown is an example only, and alternative may differ. For example, alternative embodiments may include a different number of bearings, or other types of mechanical bearings, such as cylindrical roller bearings or tapered roller bearings. Other alternative embodiments may include bearings other than mechanical bearings. For example, some alternative embodiments may include magnetic bearings, such as the axial active magnetic bearing 140 or the radial magnetic bearings of the roll-stabilizer apparatus 108 described above.

Referring back to FIGS. 26 and 27, the flywheel-support body 234 also includes electric motor/generator and 259 electrically connected (either directly or indirectly, such as indirectly through the roll-stabilizer controller 109) to the roll-stabilizer energy-storage device 110 (shown in FIG. 1) such that the electric motor/generator 259 may use electric energy stored by the roll-stabilizer energy-storage device 110 to apply a torque to the flywheel body 235 around the spin axis of rotation 237 relative to the flywheel-support body 234. In some embodiments, the electric motor/generator 259 may have multiple different windings to facilitate generating different torque profiles, which may provide higher rates of acceleration or deceleration. As used herein, the term “electric motor/generator” excludes any electrical or other connections, such as wires, studs, or plugs.

Further, the electric motor/generator 259 may convert rotational kinetic energy, from rotation of the flywheel body 235 around the spin axis of rotation 237 relative to the flywheel-support body 234, to electrical energy, and the electric motor/generator 259 is electrically connected to the roll-stabilizer energy-storage device 110 such that the roll-stabilizer energy-storage device 110 may receive and store such electrical energy converted from such rotational kinetic energy. Of course, the embodiment shown is an example only, and alternative embodiments may vary. For example, in some alternative embodiments, the electric motor/generator 259 may be electrically connected to a dedicated roll-stabilizer energy-storage device (not shown) that is external to the roll-stabilizer assembly 107 and distinct from both the main energy-storage device 105 and the roll-stabilizer energy-storage device 110.

In the embodiment shown, the electric motor/generator 259 is located entirely within the internal cavity 247 of the flywheel-support body 234. As such, when the internal cavity 247 contains the flywheel body 235 in an internal environment different than an ambient external environment, the electric motor/generator 259 will also be contained in this internal environment. In such embodiments, electrical connections (not shown) to the electric motor/generator 259 could pass through the housing 246 into the internal cavity 247.

The electric motor/generator 259 is an examples only, and alternative embodiments may differ. For example, an alternative embodiment may include only electric motors, or may include an electric motor and an electric generator separate from the electric motor. Further, an alternative embodiment may include numbers of electric motors, electric generators, or electric motor/generators that may differ from the electric motor/generator 259. Also, alternative embodiments could generate torque in other ways. For example, alternative embodiments may include a hydraulic pump and motor, or could use air power.

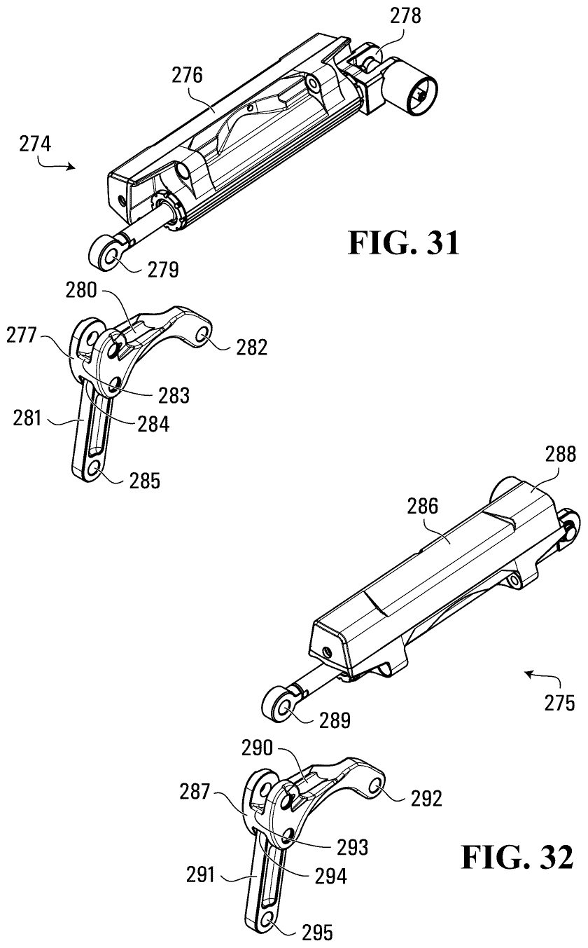

Referring now to FIGS. 25 to 27 and 29 to 31, the mounting body 236 includes a base 260 attachable to one or more other structures in the roll-stabilizer assembly 107, which may be attached to the hull 101 directly or indirectly to attach mounting body 236, and thus the roll-stabilizer apparatus 233, to the hull 101. However, in alternative embodiments, the roll-stabilizer apparatus 233 may be attached directly or indirectly to the hull 101 in other ways, or the roll-stabilizer apparatus 233 may not be attached to any hull or to any marine vessel. Therefore, in some embodiments, measurements of linear acceleration, of rotational acceleration, of orientation, or a combination of two or more thereof of the hull 101, relative to an inertial frame of reference or another frame of reference, by the inertial measurement unit 111 may indicate such acceleration, orientation, or both of the mounting body 236 relative to such a frame of reference. In other embodiments, the roll-stabilizer apparatus 233 may itself have an onboard inertial measurement unit (not shown), for example attached to the flywheel-support body 234. Therefore, references herein to movement, acceleration, or orientation of the mounting body 236, relative to an inertial frame of reference or another frame of reference, may refer to movement, acceleration, or orientation, relative to such a frame of reference, of the inertial measurement unit 111 or of any other location that may be attached directly or indirectly to the mounting body 236 or that may otherwise move with mounting body 236.

The base 260 includes base structures 261, 262, 263, and 264, which, when assembled together, form the base 260. The base structure 263 includes a precession bearing mount 265, and the base structure 264 includes a precession bearing mount 266. The mounting body 236 further includes precession bearings 267 and 268 mounted on the precession bearing mounts 265 and 266, respectively. The precession bearings 267 and 268 interface with the flywheel-support body 234 and are operable to support rotation of the flywheel-support body 234 relative to the base 260 of the mounting body 236 around a precession axis 269.

The base structures 261, 262, 263, and 264 are spaced apart from each other to define a space between the base structures 261, 262, 263, and 264 to receive the flywheel-support body 234. The space between the base structures 261, 262, 263, and 264 is sized and shaped to permit rotation of the flywheel-support body 234 relative to the mounting body 236 around the precession axis 269. In the embodiment shown, the precession axis 269 is generally perpendicular to the spin axis of rotation 237 of the flywheel body 235. However, in alternative embodiments, the precession axis 269 may be non-parallel to, and not necessarily perpendicular to, the spin axis of rotation 237.

In some embodiments, movement of the flywheel-support body 234 relative to the mounting body 236 may be constrained to rotation of the flywheel-support body 234 relative to the mounting body 236 around the precession axis 269. However, alternative embodiments may differ. For example, in alternative embodiments, the flywheel-support body 234 may be mounted for both translation and rotation relative to the mounting body 236, for example using a linkage such as a four-bar linkage.

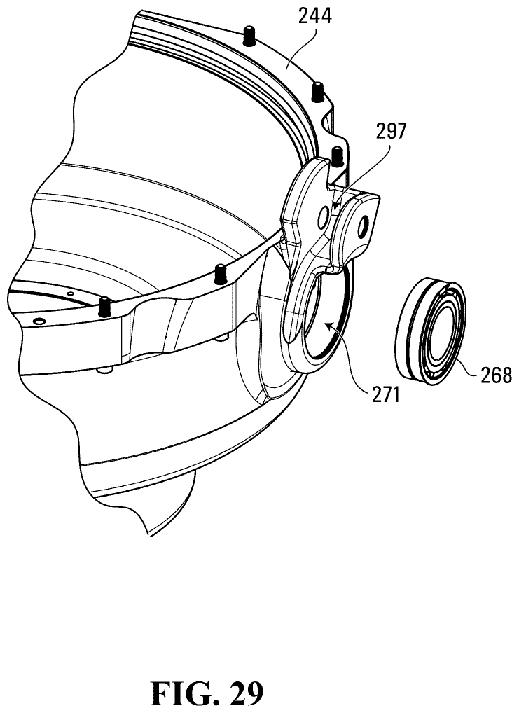

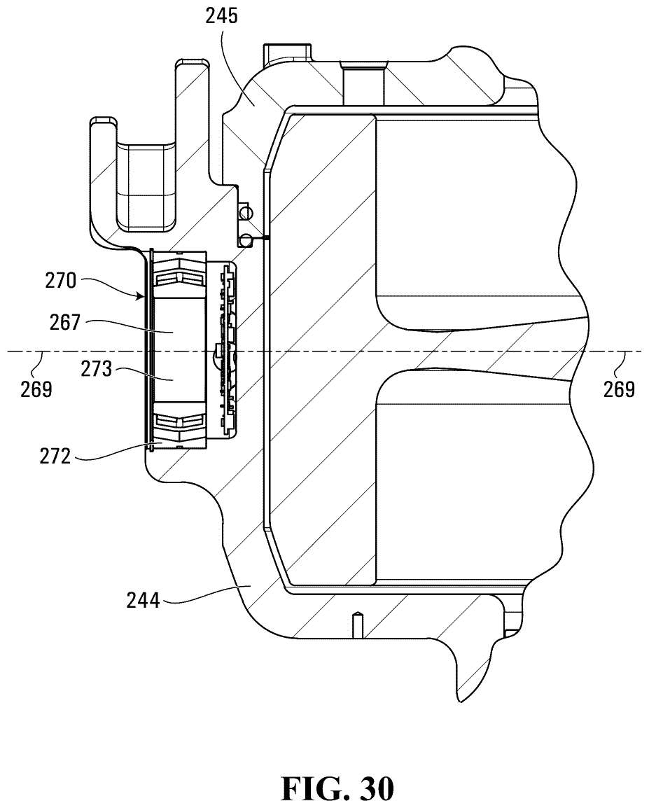

Referring now to FIGS. 26, 27, 29, and 30, in the embodiment shown, the precession bearings 267 and 268 support the flywheel-support body 234 by being positioned in and interfacing with precession bearing sockets, shown generally at 270 and 271, which are integrated directly into the housing body 244 of the flywheel-support body 234. FIG. 29 provides a more detailed view of the precession bearing socket 271 for precession bearing 268. The precession bearings 267 and 268 in the embodiment shown are mechanical bearings. Considering as an example the precession bearing 267 as shown in greater detail in FIG. 30, the precession bearing 267 includes an outer precession race 272 and an inner precession race 273. The outer precession race 272 is fixed to the housing body 244 within the precession bearing socket 270, while the inner precession race 273 interfaces with the precession bearing mount 265 of the base structure 263 of the mounting body 236. In some embodiments, the inner precession race 273 may be fixed to the precession bearing mount 265. However, in other embodiments, the inner precession race 273 may be a “floating” inner precession race, movable axially along the precession bearing mount 265 (i.e., along the precession axis 269). A “floating” inner race may be required to accommodate thermal expansion. The outer precession race 272 is operable to rotate relative to the inner precession race 273 and thus relative to the precession bearing mount 265 and, ultimately, the mounting body 236. As such, each of the precession bearings 267 and 268 includes an outer precession body (i.e., the outer precession race 272 of the precession bearing 267) that is rotatable relative to the mounting body 236, and rotation of these outer precession bodies enables the flywheel-support body 234 to rotate relative to the mounting body 236. Of course, the embodiment shown is an example only, and alternative may differ. For example, alternative embodiments may include a different number of precession bearings. Other alternative embodiments may include bearings other than mechanical bearings.

Referring now to FIGS. 25 to 27 and 31 to 35, the mounting body 236 also includes precession-control devices 274 and 275 operable to control rotation of the flywheel-support body 234 relative to the mounting body 236 around the precession axis 269. In general, a precession-control device may include an actuator, which may be a linear actuator or a torsional actuator, and which may be an electromechanical actuator, a hydraulic actuator, or a pneumatic actuator. Further, a precession-control device may include a shock absorber, a damper, an electric generator, or another device that can apply a resistive torque to the flywheel-support body 234 relative to the mounting body 236 to dampen the rotation of the flywheel-support body 234 relative to the mounting body 236.

The precession-control device 274 includes a linear actuator 276 and a precession linkage 277. The linear actuator 276 includes a mounting body end 278 and a force-transfer body end 279. The precession linkage 277 includes a first force-transfer body 280 and a second-force transfer body 281. The first force-transfer body 280 includes a flywheel-support body end 282 and an actuator end 283. The second-force transfer body 281 includes a force-transfer linkage end 284 and a constraining end 285. The mounting body end 278 of the linear actuator 276 is rotatably attached to the base structure 263 of the base 260. The flywheel-support body end 282 of the first force-transfer body 280 is rotatably attached to the flywheel-support body 234. The actuator end 283 of the first force-transfer body 280 is rotatably attached to the force-transfer body end 279 of the linear actuator 276 and also to the force-transfer linkage end 284 of the second force-transfer body 281. The constraining end 285 of the second force-transfer body 281 is rotatably attached to the base structure 263 of the base 260. Through the rotatable connections described above, the first force-transfer body 280 is connected to both the linear actuator 276 and the flywheel-support body 234, and is therefore operable to transfer force between the linear actuator 276 and the flywheel-support body 234. Further, the rotatable connection between the first force-transfer body 280 and the flywheel-support body 234 is positioned at a distance away from the precession axis 269, such that linear extension or contraction of the linear actuator 276 may, by transferring force through the first force-transfer body 280, apply a torque to and cause and/or resist rotation of the flywheel-support body 234 around the precession axis 269 relative to the base 260 of the mounting body 236, and, correspondingly, such that rotation of the flywheel-support body 234 around the precession axis 269 relative to the base 260 may cause linear extension or contraction of the linear actuator 276. The rotatable connection between the mounting body end 278 of the linear actuator 276 and the base structure 263, together with the second-force transfer body 281 and its rotable connections to the first force-transfer body 280 and the base structure 263, constrain a range of motion of the flywheel-support body 234, the linear actuator 276, and the first force-transfer body 280 such that the force transferred through the first force-transfer body 280 may be close to linearly related to the torque applied to the flywheel-support body 234.

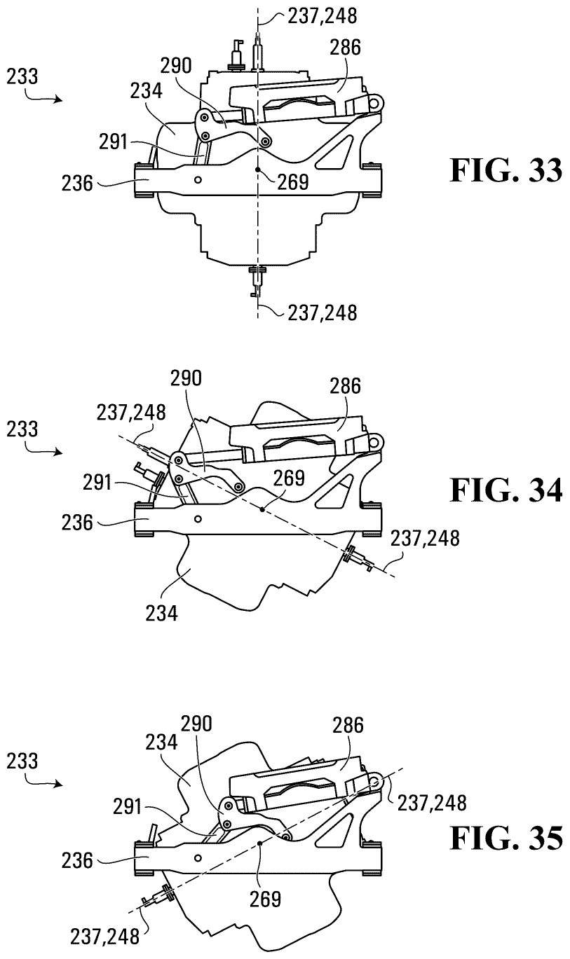

Similarly, the precession-control device 275 includes a linear actuator 286 and a precession linkage 287. The linear actuator 286 includes a mounting body end 288 and a force-transfer body end 289. The precession linkage 287 includes a first force-transfer body 290 and a second force-transfer body 291. The first force-transfer body 290 includes a flywheel-support body end 292 and an actuator end 293. The second force-transfer body 291 includes a force-transfer linkage end 294 and a constraining end 295. The mounting body end 288 of the linear actuator 286 is rotatably attached to the base structure 264 of the base 260. The flywheel-support body end 292 of the first force-transfer body 290 is rotatably attached to the flywheel-support body 234. The actuator end 293 of the first force-transfer body 290 is rotatably attached to the force-transfer body end 289 of the linear actuator 286 and also to the force-transfer linkage end 294 of the second force-transfer body 291. The constraining end 295 of the second force-transfer body 291 is rotatably attached to the base structure 264 of the base 260. Through the rotatable connections described above, the first force-transfer body 290 is connected to both the linear actuator 286 and the flywheel-support body 234, and is therefore operable to transfer force between the linear actuator 286 and the flywheel-support body 234. Further, the rotatable connection between the first force-transfer body 290 and the flywheel-support body 234 is positioned at a distance away from the precession axis 269, such that linear extension or contraction of the linear actuator 286 may, by transferring force through the first force-transfer body 290, apply a torque to and cause rotation of the flywheel-support body 234 around the precession axis 269 relative to the base 260 of the mounting body 236, and, correspondingly, such that rotation of the flywheel-support body 234 around the precession axis 269 relative to the base 260 may cause linear extension or contraction of the linear actuator 286. The rotatable connection between the mounting body end 288 of the linear actuator 286 and the base structure 264, together with the second force-transfer body 291 and its rotable connections to the first force-transfer body 290 and the base structure 263, constrain a range of motion of the flywheel-support body 234, the linear actuator 286, and the first force-transfer body 290 such that the force transferred through the first force-transfer body 290 may be close to linearly related to the torque applied to the flywheel-support body 234. FIGS. 33 to 35 provide a demonstration of this force-transfer relationship.

In the embodiment shown, each of the rotatable connections between the flywheel-support body 234 and the first force-transfer bodies 280 and 290 of the precession-control devices 274 and 275, respectively, is positioned such that it at least partly overlaps with a width of the precession bearings 267 and 268, respectively, along the precession axis 269. More specifically, as shown in particular in FIG. 27, the housing body 244 of the flywheel-support body 234 includes a linkage socket shown generally at 296 which is positioned such that it at least partly overlaps with a width of the precession bearing 267 along the precession axis 269, and also includes a linkage socket shown generally at 297 which is positioned such that it at least partly overlaps with a width of the precession bearing 268 along the precession axis 269. The flywheel-support body ends 282 and 292 of the first force-transfer bodies 280 and 290, respectively, are rotatably connected to the housing body 244 within the linkage sockets 296 and 297, respectively. Similarly, each of the rotatable connections between the first force transfer bodies 280 and 290 and the second force-transfer bodies 281 and 291, between the first force transfer bodies 280 and 290 and the linear actuators 276 and 286, between the linear actuators 276 and 286 and the base structures 263 and 264, and between the second force-transfer bodies 281 and 291 and the base structures 263 and 264 is positioned such that it at least partly overlaps with a width of the precession bearings 267 and 268 along the precession axis 269.

Thus, each of the precession-control devices 274 and 275 is operable to apply a force at least partly overlapping a width of a respective precession bearing (i.e., the precession bearing 267 or the precession bearing 268, respectively) along the precession axis 269. Furthermore, because the precession bearings 267 and 268 are fixed to the flywheel-support body 234 within the precession bearing sockets 270 and 271, respectively, which are integrated directly into the flywheel-support body 234, the precession-control devices 274 and 275 are operable to apply forces to the flywheel-support body 234 at least partly overlapping a width of the precession bearings along the precession axis 269. Compared to other embodiments that have linkages occupying space between the mounting body 236 and the flywheel-support body 234 (and thus requiring a gap along the precession axis 269 between the mounting body 236 and the flywheel-support body 234), the configuration of the embodiment shown may permit a larger allowable size of the flywheel body 235 for a given size of the roll-stabilizer apparatus 233.

For example, with reference to FIG. 25, the size of the roll-stabilizer apparatus 233 may be considered to be represented by a width W of the base 260 of the mounting body 236 along the precession axis 269, extending from an outermost surface of the base structure 263 to an outermost surface of the base structure 264. Similarly, with reference to FIG. 27, the size of the flywheel body 235 may be considered to be represented by a diameter D of the flywheel body 235. Using these definitions, the configuration of the embodiment shown may allow a ratio of the diameter D to the width W to be greater than 62%. For example, in the embodiment shown, the ratio D:W may be about 63%, about 64%, about 65%, about 66%, about 67%, about 68%, about 69%, about 70%, about 71%, about 72%, about 73%, or about 74%. A larger flywheel body (i.e., with a larger radius) may generally allow a greater moment of inertia. Because of this, larger flywheel bodies may generally require a lower rotation speed to achieve a given angular momentum for roll stabilization. Lower operational rotation speeds may be advantageous because they can correspond to longer bearing life and lower power draw. Additionally, at lower speeds, there is less energy stored in the flywheel, which corresponds to shorter spin-up/spin-down times, as well as greater safety.

The description above refers to widths of precession bearings along the precession axis 269 and refers to a width W of the base 260 along the precession axis 269. Such widths may describe embodiments in which the precession axis 269 extends horizontally and perpendicular to the longitudinal axis 106, namely transversely relative to the hull 101. However, references to widths of precession bearings and to a width W of a base may be understood more generally as references to dimensions that may be but are are not necessarily widths. For example, in an embodiment in which a precession axis is vertical, generally vertical, or normal to or otherwise outside of a plane including longitudinal and transverse axes of at least one hull, references to widths of precession bearings and to a width W of a base may be understood as references to vertical or other dimensions that are not necessarily widths.

Referring now to FIGS. 25 and 26, in the embodiment shown, the flywheel-support body 234 includes a flywheel controller 298 in communication with the roll-stabilizer controller 109 (shown in FIG. 1) and with the electric motor/generator 259. The flywheel controller 298 may receive one or more control signals from the roll-stabilizer controller 109, and the flywheel controller 298 may in turn send one or more control signals to the electric motor/generator 259 to control the torque applied by the electric motor/generator 259 to the flywheel body 235 around the spin axis of rotation 237, and/or the speed of rotation of the flywheel body 235 around the spin axis of rotation 237. Mounting of the flywheel controller 298 directly on the flywheel-support body 234 may minimize an amount of wiring required to provide control of the electric motor/generator 259. In some embodiments, the flywheel controller 298 may send one or more control signals to the electric motor/generator 259 to control the electric motor/generator 259 to vary the speed at which the flywheel body 235 rotates around the spin axis of rotation 237 depending on sea conditions. For example, the flywheel controller 298 may send control signals to the electric motor/generator 259 to cause the flywheel body 235 to rotate slowly in calm seas, which may save energy, and may send control signals to the electric motor/generator 259 to cause the flywheel body 235 to rotate quickly in rough seas, thus providing greater stabilization. This variable rotation speed control of the flywheel body 235 provided by the flywheel controller 298 may include multiple flywheel body 235 rotation speeds, or a continuous range of flywheel body 235 rotation speeds.

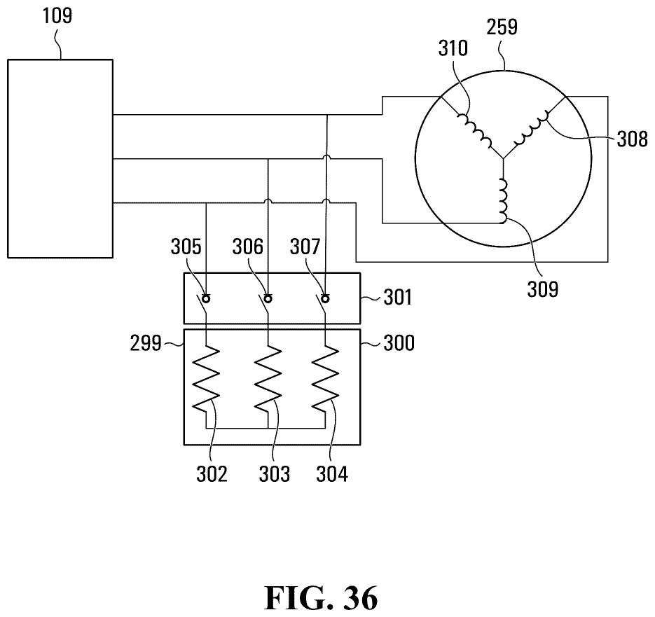

Referring now to FIG. 36, in some embodiments, the electric motor/generator 259 may also be in electrical communication with a brake circuit such as brake circuit 299. The brake circuit 299 includes a resistor bank 300 and a switch bank 301. In the embodiment shown, the resistor bank 300 includes resistors 302, 303, and 304, and the switch bank 301 includes switches 305, 306, and 307. The switches 305, 306, and 307 are operable to reversibly electrically connect the electric motor/generator 259 to the resistors 302, 303, and 304. Connection of the electric motor/generator 259 to the resistors 302, 303, and 304 may short circuit phase windings 308, 309, and 310 of the electric motor/generator 259 and may thus cause the electric motor/generator 259 to apply a resistive torque to the flywheel body 235 relative to the flywheel-support body 234 to dampen the rotation of the flywheel body 235 relative to the flywheel-support body 234. In the embodiment shown in FIG. 36, the brake circuit 299 is in communication with the roll-stabilizer controller 109 to receive one or more control signals from the roll-stabilizer controller 109. For example, the roll-stabilizer controller 109 may be operable to provide braking signals to the brake circuit 299. In response to these braking signals, the switches 305, 306, and 307 of the brake circuit 299 may be configured to connect the electric motor/generator 259 to the resistors 302, 303, and 304. The switches 305, 306, and 307 may also be configured to connect the electric motor/generator 259 to the resistors 302, 303, and 304 in response to, for example, a failure of the roll-stabilizer controller 109.

Each of the precession-control devices 274 and 275 is also in communication with the roll-stabilizer controller 109 to receive one or more control signals from the roll-stabilizer controller 109. The one or more control signals received from the roll-stabilizer controller 109 may be used to control the precession-control devices 274 and 275, as described above with respect to the precession-control devices 120 and 121 of the roll-stabilizer apparatus 108. Further, each of the precession-control devices 274 and 275 is an electromechanical actuator operable to extend and contract to apply a torque to, and to rotate, the flywheel-support body 234 around the precession axis 269 relative to the base 260 in response to, at least, one or more control signals from the roll-stabilizer controller 109. Such a torque applied by the precession-control devices 274 and 275 may differ from a resistive torque because, for example, a torque applied by the precession-control devices 274 and 275 may cause rotation of the flywheel-support body 234 around the precession axis 269 relative to the base 260 in a same direction as the applied torque, and the applied torque may be independent of rotation of the flywheel-support body 234 around the precession axis 269 relative to the base 260.

Further, each of the precession-control devices 274 and 275 is operable to generate electrical energy from rotation of the flywheel-support body 234 around the precession axis 269 relative to the base 260 and thereby dampen precession of the flywheel-support body 234 around the precession axis 269 relative to the base 260. The precession-control devices 274 and 275 are electrically connected to the roll-stabilizer energy-storage device 110 such that electrical energy generated by the precession-control devices 274 and 275 may be stored by the roll-stabilizer energy-storage device 110.

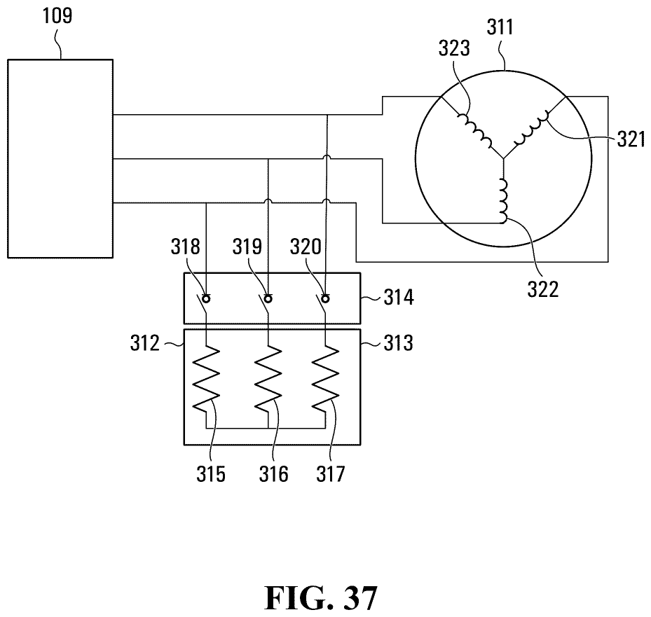

Referring now to FIG. 37, in some embodiments, each of the linear actuators 276 and 286 of the precession-control devices 274 and 275 may have an actuator motor, such as actuator motor 311. The actuator motor 311 may be in electrical communication with a damping circuit such as damping circuit 312. The damping circuit 312 includes a resistor bank 313 and a switch bank 314. In the embodiment shown, the resistor bank 313 includes resistors 315, 316, and 317, and the switch bank 314 includes switches 318, 319, and 320. The switches 318, 319, and 320 are operable to reversibly electrically connect the actuator motor 311 to the resistors 315, 316, and 317. Connection of the actuator motor 311 to the resistors 315, 316, and 317 may short circuit phase windings 321, 322, and 323 of the actuator motor 311 and may thus cause the actuator motor 311 to apply a resistive torque to the flywheel-support body 234 relative to the mounting body 236 to dampen the rotation of the flywheel-support body 234 relative to the mounting body 236. In some embodiments, the damping circuit 312 may be in communication with the roll-stabilizer controller 109 to receive one or more control signals from the roll-stabilizer controller 109. For example, the roll-stabilizer controller 109 may be operable to provide damping signals to the damping circuit 312. In response to these damping signals, the switches 318, 319, and 320 may be configured to connect the actuator motor 311 to the resistors 315, 316, and 317. The switches 318, 319, and 320 may also be configured to connect the actuator motor 311 to the resistors 315, 316, and 317 in response to, for example, a failure of the roll-stabilizer controller 109 or a loss of power.

In some embodiments, minimizing backlash or lost motion between the flywheel-support body 234 and the precession-control devices 274 and 275, or between the mounting body 236 and the precession-control devices 274 and 275, may be important for controlling stability.

However, alternative embodiments may differ. For example, alternative embodiments may include more or fewer precession-control devices that may differ from the precession-control devices 274 and 275. For example, a precession-control device according to an alternative embodiment may include a different electromechanical actuator, a different electric generator, or both, and some embodiments may omit such precession-control devices. Further, alternative embodiments may differ and may include hydraulic actuators, torsional actuators, or both, for example. Also, precession-control devices of alternative embodiments need not be actuators, but could apply only resistive forces or torques that simply resist or dampen movement of the flywheel-support body 234 relative to the mounting body 236.

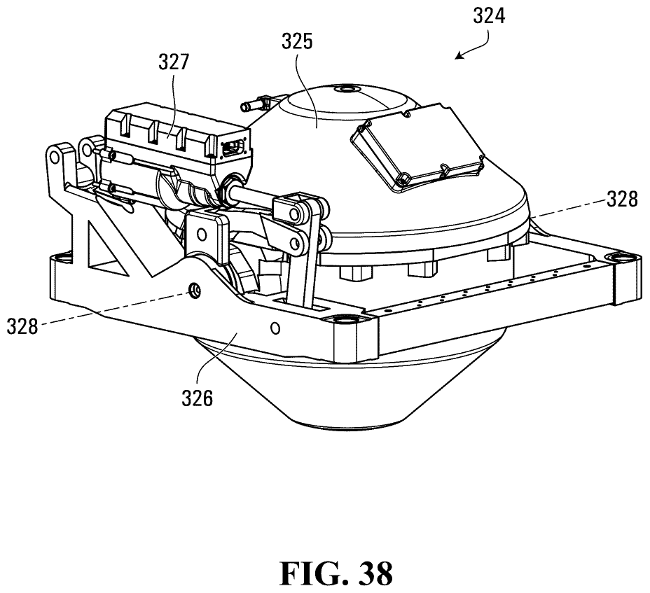

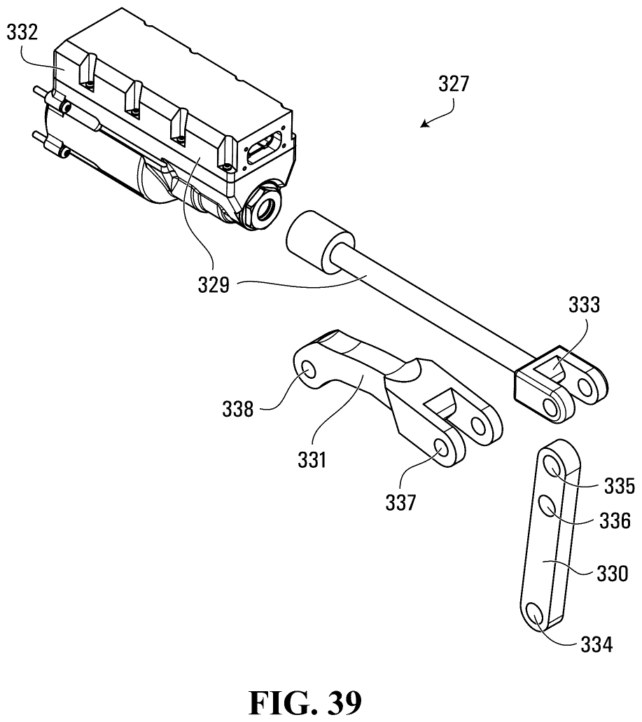

One example of an alternative embodiment with a different precession-control device is provided in FIGS. 38 and 39. In FIG. 38, a roll-stabilizer apparatus according to this alternative embodiment is shown generally at 324 and, similar to the roll-stabilizer apparatus 233, includes a flywheel-support body 325, a flywheel body (not shown) inside the flywheel-support body 325, a mounting body 326, and a precession-control device 327. The precession-control device 327 of the roll-stabilizer apparatus 324 is similar to the precession-control devices 274 and 275 of the roll-stabilizer apparatus 233, and is operable to control rotation of the flywheel-support body 325 relative to the mounting body 326 around a precession axis 328.

As with the precession axis of rotation 119 and the precession axis 269, the precession axis 328 in some embodiments may extend horizontally and perpendicular to the longitudinal axis 106, namely transversely relative to the hull 101. However, alternative embodiments may differ. For example, in some embodiments, the precession axis 328 may extend vertically or in another direction that is not parallel (and that may be perpendicular) to the longitudinal axis 106 of the marine vessel 100.

However, as shown in greater detail in FIG. 39, the precession-control device 327 has a different configuration than the precession-control devices 274 and 275. More specifically, the precession-control device 327 includes an actuator 329, a first force-transfer body 330, and a second force-transfer body 331. The actuator 329 includes a mounting body end 332 and a force-transfer body end 333; the first force-transfer body 330 includes a constraining end 334, an actuator end 335, and a force-transfer linkage portion 336; and the second force-transfer body 331 includes a force-transfer linkage end 337 and a flywheel-support body end 338. The mounting body end 332 of the actuator 329 is rotatably attached to the mounting body 326. The constraining end 334 of the first force-transfer body 330 is also rotatably attached to the mounting body 326. The actuator end 335 of the first force-transfer body 330 is rotatably attached to the force-transfer body end 333 of the actuator 329. The force-transfer linkage end 337 of the second force-transfer body 331 is rotatably attached to the force-transfer linkage portion 336 of the first force-transfer body 330. The flywheel-support body end 338 of the second force-transfer body 331 is rotatably attached to the flywheel-support body 325. Through the rotatable connections described above, the first force-transfer body 330 and the second force-transfer body 331 are operable to transfer force between the actuator 329 and the flywheel-support body 325. Further, the rotatable connection between the second force-transfer body 331 and the flywheel-support body 325 is positioned at a distance away from the precession axis 328, such that linear extension or contraction of the actuator 329 may, by transferring force through the first force-transfer body 330 and the second force-transfer body 331, apply a torque to and cause and/or resist rotation of the flywheel-support body 325 around the precession axis 328 relative to the mounting body 326, and, correspondingly, such that rotation of the flywheel-support body 325 around the precession axis 328 relative to the mounting body 326 may cause linear extension or contraction of the actuator 329.

In the embodiment shown in FIGS. 25 and 26, the base 260 of the mounting body 236 also includes mounting feet, such as mounting foot 339 and mounting foot 340 attached to the base structure 264. The mounting feet 339 and 340 are operable to mount the base 260, and thus the mounting body 236, to at least one hull of a vessel, such as the hull 101 of the marine vessel 100. In some embodiments, the mounting feet 339 and 340 may be interchangeable with other mounting feet to allow for different mounting configurations. For example, the mounting feet of some embodiments may allow for adjustable mounting or for mounting to non-flat surfaces.

The mounting feet 339 and 340 are examples only, and alternative embodiments may differ. For example, alternative embodiments may include openings, which may be threaded, to receive bolts or other structures that may mount the base 260, and thus the mounting body 236, to at least one hull of a vessel. Other embodiments may include clamps, connectable support bodies, or other structures that may be interchangeable and that may mount the base 260, and thus the mounting body 236, to at least one hull of a vessel.

As with the precession axis of rotation 119, the precession axis 269 in some embodiments may extend horizontally and perpendicular to the longitudinal axis 106, namely transversely relative to the hull 101. However, alternative embodiments may differ. For example, in some embodiments, the precession axis 269 may extend vertically or in another direction that is not parallel (and that may be perpendicular) to the longitudinal axis 106 of the marine vessel 100.

The mounting feet 339 and 340, or other structures such as those described above for example, may be positioned, orientated, or both such that the mounting body 236 is configured to be attached to at least one hull of a marine vessel such that the precession axis 269 extends transversely relative to the at least one hull. Other mounting bodies, such as the mounting bodies 114 and 326, may include similar mounting feet or other structures that as those described above to mount the mounting bodies to at least one hull of a vessel.

### Interchangeability of Embodiments

Elements of embodiments as described above may be interchangeably used in other embodiments described above. For example, the flywheel assembly 115, the stators 138 and 139, and the axial active magnetic bearing 140 of the roll-stabilizer apparatus 108 may be interchangeable with the flywheel body 235, the rotation-support body 250, and the bearings 252 and 253 of the roll-stabilizer apparatus 233. Similarly, the precession-control devices 274 and 275, and/or the precession bearings 267 and 268, of the roll-stabilizer apparatus 233 may be used to control and support rotation of the flywheel-support body 113 around the precession axis of rotation 119 in the roll-stabilizer apparatus 108. The mounting feet 339 and 340 of the mounting body 236 of the roll-stabilizer apparatus 233 may also be used to mount the mounting body 114 of the roll-stabilizer apparatus 108 to the hull 101.

### CONCLUSION

Roll-stabilization apparatuses such as those described herein, for example, may be for marine vessels and may be preferable to other roll-stabilization apparatuses. For example, other active magnetic bearings may not have sufficient strength or controllability, or may be too large, for practical applications in roll stabilization.

Although specific embodiments have been described and illustrated, such embodiments should be considered illustrative only and not as limiting the invention as construed according to the accompanying claims.

1. A roll-stabilizer apparatus comprising:
a flywheel-support body comprising a rotation-support body;
a flywheel body surrounding at least a portion of the rotation-support body, wherein the rotation-support body supports the flywheel body for rotation relative to the flywheel-support body around at least one axis of rotation comprising a spin axis of rotation of the flywheel body and a central-rotation axis of the flywheel-support body; and
a mounting body supporting the flywheel-support body and permitting rotation of the flywheel-support body relative to the mounting body around a precession axis non-parallel to the at least one axis of rotation.

2-154. (canceled)
